(19) United States
(12) Patent Application Publication
(10) Pub. No.: US 2022/0051253 A1
(43) Pub. Date: Feb. 17, 2022

(54) METHODS FOR REMOTE TRANSACTION RECEIPT CAPTURE BASED ON EVIDENCE OF A TRANSACTION IN PROGRESS

(71) Applicant: Peter Garrett, San Francisco, CA (US)

(72) Inventor: Peter Garrett, San Francisco, CA (US)

(21) Appl. No.: 17/104,922

(22) Filed: Nov. 25, 2020

Related U.S. Application Data
(63) Continuation-in-part of application No. 16/991,934, filed on Aug. 12, 2020.
Application No. 16/991,934 is a continuation-in-part of application No. 16/997,746, filed on Aug. 19, 2020.
Application No. 16/997,746 is a continuation-in-part of application No. 17/013,591, filed on Sep. 5, 2020.
Application No. 17/013,591 is a continuation-in-part of application No. 17/062,574, filed on Oct. 3, 2020.
Application No. 17/062,574 is a continuation-in-part of application No. 17/013,591, filed on Sep. 5, 2020.
Application No. 17/013,591 is a continuation-in-part of application No. 16/997,746, filed on Aug. 19, 2020.
Application No. 16/997,746 is a continuation-in-part of application No. 16/991,934, filed on Aug. 12, 2020.

(51) Int. Cl. G06Q 20/40; G06Q 20/32; G06Q 20/36; G06Q 20/34

(52) U.S. Cl. CPC G06Q 20/4016; G06Q 20/346; G06Q 20/36; G06Q 20/321

(57) ABSTRACT

A method is provided for remotely activating a transaction receipt capture process on a mobile device through a client application from a network-connected cloud-based money payment or wallet service in light of an account issued to a user and incorporated into the service. The method includes the user selecting an account listed in the service through the client application while connected to the service, the user receiving transactional data or otherwise confirmation of account selection, the user submitting the transactional data to a point of sale (POS) terminal, the POS terminal reading the submitted transactional data and approving or denying the transactional data, the service receiving notification of or discovering account activity relative to the user account selected, and the service sending a command to the mobile phone client application to activate a camera or scanning application feature on the mobile phone through an extension in the client application.

### CROSS-REFERENCE TO RELATED DOCUMENTS

The present invention claims priority to a U.S. patent application Ser. No. 17/062,580, entitled “Method for Transfer and Aggregation of Electronic Receipts” filed on Oct. 3, 2020, which is a continuation in part (CIP) to a U.S. patent application Ser. No. 17/062,574, entitled “Receipt Aggregation Model”, filed on Oct. 3, 2020, which is a continuation in part (CIP) to a U.S. patent application Ser. No. 17/013,591 entitled “Method for Voice Tagging an Electronic Receipt acquired after a Transaction” filed on Sep. 5,2020, which is a continuation in part (CIP) to a U.S. patent application Ser. No. 16/997,746 entitled “Method of Electronic Receipt Capture for real-time Transacted Expenditures” filed on Aug. 19, 2020 the disclosure of which is included herein at least by reference.

### BACKGROUND OF THE INVENTION

### 1. Field of the Invention

The present invention is in the field of financial transacting including over a network and pertains particularly to methods and apparatus for capturing electronic transaction receipts linked to user accounts from a remote cloud wallet or money pay service storing the account.

### 2. Discussion of the State of the Art

Payment cards are part of a payment system used by financial institutions like banks, for example, to enable cardholders to access funds held in designated bank accounts or credit accounts. The cardholder may make payments by electronic funds transfer (EFT) and access automated teller machines (ATM's). There are several types of payment cards in the art, perhaps the most common classes being credit cards and debit cards.

A more recent type of payment card existing in the art is generally termed a smart card in the art. Smart cards are payment cards that contain a unique card number and some security information such as an expiration date or card verification value (CVV) and a magnetic strip and an embedded euro-pay master card and visa (EMV) chip (secure element) enabling various machines (transaction point terminals) like point of sale (POS) machines to read and access information from the card.

More recently, smart cards have been adapted as mobile dynamic smart transaction cards. A dynamic smart card may have multiple payment card data dynamically loaded onto the single form factor of the card. A user may add any or all payment card data from debit, credit, and loyalty accounts to a mobile application associated with the smart card, such as into a cloud wallet application. The user may load the data onto the smart card via Bluetooth wireless technology or any other wireless technology.

All-in-one smart cards are referred to in the field as dynamic smart cards. An owner of a dynamic smart card may load multiple payment account data sets onto a single payment card form factor. A user may add payment card data sets for debit, credit, gift, and loyalty to the dynamic smart card. For example, the user may leverage a mobile phone application (executed on phone) such as a mobile wallet application associated with the dynamic smart card to authenticate (identity, confirm) and move the payment card data sets onto the dynamic smart card over a Bluetooth™ or other wireless network connection between the user's smart phone and the dynamic smart card before the card is used in a transaction.

One important aspect of an expenditure is whether or not the expenditure or part of the expenditure may be a tax deduction. In general practice some applications like bank card applications tied to banks may enable a user working in the application to browse expenditure items by category and item specifics for the purpose of assigning items as tax-deductible expenditures made by the user. However, the user must navigate much data to find entries for marking as tax deductible entries. Moreover, such institutions are not required or set up to record any additional information other than the expense and the payee. With more complex payment services including dynamic smart cards to which any wallet cloud stored card may be represented it may be desired that potential tax-deductible expenditures might be marked and categorized in real time just before a card purchase is made.

One problem that arises is managing the location of receipts that back up and validate claimed expenditures used to reduce tax burden. Hard receipts are still quite common in our digital experience and are often misplaced or lost, become ink faded and illegible, and accidentally thrown away.

The inventor is aware of a system that enables a user to capture receipts form a POS terminal or from Email or messaging accounts during or just after a transaction is made by the user resulting in the receipt being captured onto the mobile phone or other mobile device hosting a transaction made from a transaction card or wireless transaction device and then uploaded to the mobile phone.

In the system known to the inventor, the user runs a wallet application or other money pay application on the mobile telephone that includes extensions connected to other useful applications available on the mobile phone such as a camera feature for taking a picture of a hard printed receipt, scanning a receipt using an optical character recognition feature, or retrieving a receipt after it is sent electronically to a user address on the network for email or from text services.

Typically a wireless signal, push notification, or wireless command is communicated to the user mobile phone wallet application as a transaction device is read wherein the signal, notification, or command is received by the running wallet application typically connected to a cloud server where stored receipts may be kept in an organized fashion for later access by the user or an agent working on behalf of the user with authorization from the user. One feature of the system is that however the receipt is captured, it immediately displays in an application screen in the wallet or money pay application and controls may appear on screen that may allow the user to save or not save the receipt, assign a general business category to the receipt, including flagging the receipt for tax deduction purposes and filing the receipt for upload to the cloud server hosting the wallet account or money pay application.

It may be desired by a user to be able to more specifically characterize the receipt including input describing specific circumstances in the environment of the transaction, which otherwise may be forgotten if not actively recorded. Such information may help the user recall what led to the receipt more than a transaction receipt would reveal.

The inventor is aware of a method and apparatus for electronically characterizing captured receipts through a wallet or money pay application feature that may trigger just after a transaction, the characterizations attached as data to aggregated receipts before archiving the aggregated receipts for later retrieval. After a receipt is captured, a prompt may appear in a mobile application on the user's mobile phone enabling the user to characterize the receipt captured using one of an audio recording feature or a voice-to text-feature resident on the host computing device.

In many retail POS transactions, receipts are emailed to the user's email address on file or given at the time of the transaction. Such receipts may or may not be immediately sent to the user account. In most cases the user must remember the receipt and monitor email message for the arrival of the receipt before the user may retrieve (download) the receipt. Although a user might use a monitoring feature to identify receipts from a transaction amongst other email messages they application must be monitored by the user for state (on off) and the application may not catch all receipts from transactions or my catch receipts that the user did not want to capture.

A cloud wallet service typically receives notification of a transaction made by a user at a POS terminal by an issuing financial institution of the account or card used upon approval of and completion of the transaction. In this way, a user may manage his or her account through the cloud wallet payment application, a thin software client, residing on the mobile device like a mobile phone carried by the user.

It has occurred to the inventor that while receipt capture notifications may be received by the thin client application on the mobile device using a variety of paths, many are dependent on technology available like Bluetooth and capabilities and processes of a POS terminal. For example, a card issuing institution may delay use notification for some time as is the case with email notifications. Direct card notifications to the mobile phone application require the card to carry wireless communications and to run firmware for recording the transaction and notifying the application running on the phone. This may limit the effectiveness of overall receipt capture aggregation and management.

Therefore, what is needed in the art is a method for transaction receipt capture notification and capture technology activation that is automated to provide seamless activation of camera technology to capture a receipt based on evidence of a transaction in progress in real time.

### BRIEF SUMMARY OF THE INVENTION

According to an embodiment of the present invention, a method is provided for remotely activating a transaction receipt capture process on a mobile device through a client application from a network-connected cloud-based money payment or wallet service in light of an account issued to a user and incorporated into the service the method including the steps (a) the user selecting an account listed in the service through the client application while connected to the service, (b) the user receiving transactional data or otherwise confirmation of account selection at the mobile phone in the client application, (c) the user submitting the transactional data to a point of sale (POS) terminal to complete the transaction, (d) at the POS terminal, reading the submitted transactional data and approving or denying the transactional data for completing the transaction, (e) at the service, receiving notification of or discovering account activity relative to the user account selected in (a), and (f) at the service, sending a command to the mobile phone client application of the user to activate a camera or scanning application feature on the mobile phone through an extension in the client application.

(It should be noted here that a receipt capture process/session could include any of the following; notification from the cloud wallet, that a transaction has occurred and does the user want capture that receipt with smartphone camera; receiving a notification from a dynamic smartcard via bluetooth to a smartphone that a transaction has occurred and does the user want to capture receipt; receiving a notification that a transaction has occurred using a smartcard and the smartcard asking the user if a receipt is desired, The receipts may be received via email, text, a copy straight to the cloud wallet receipt aggregation facility or a copy to the smartphone which then can be forwarded to the cloud wallet receipt aggregation facility)

In one aspect of the method, the network is the Internet network including any sub-networks connected thereto. In one aspect, in (c) the transaction device is a dynamic transaction card enabled for wireless communications with the mobile device acting as a host device. In another aspect, in (c) the transaction device is the mobile phone enabled with near field communication (NFC). In yet another aspect in (c), the transaction device is a wearable device like a watch enabled for wireless communications with the mobile phone acting as the host device.

In one aspect of the method, the method further includes a step in between step (b) and (c) for selecting or establishing a time window within which one or more transactions will be attempted using the selected account. In one aspect, in step (c) the transactional data is submitted to the POS terminal directly from the mobile phone operating as the transaction device. In another aspect, in step (c) the transactional data is submitted to the POS terminal through a dynamic transaction card. In still another aspect, in step (c) the transactional data is submitted to the POS terminal through a wearable transaction device like a watch.

In all aspects of the method, in step (d) approving or denying the transactional data for completing the transaction is performed at the account issuing entity at request of the POS terminal. In one aspect, in step (e) the service receives notification of account activity from the issuing entity. In another aspect, in step (e) the service discovers the account activity through active monitoring of a server servicing the account or active monitoring of the electronic account. In one aspect wherein notification is received at the service, the notification includes approval or denial of the transactional data. In another aspect wherein the service discovers the account activity, the discovery includes flagging or marking the account for pending credit or debit based on the transactional nature.

In one aspect of the invention, in step (f) the client application is operating in background mode and executes to foreground mode at the moment of execution of the received command to activate the camera or scanner application feature. In one aspect step (c), the transaction device is a dedicated card having a resident card number.

### BRIEF DESCRIPTION OF THE SEVERAL VIEWS OF THE DRAWINGS

FIG. 1 is an architectural view of a communications network that supports real-time electronic receipt capture and aggregation according to an embodiment of the present invention.

FIG. 2 is an elevation view of the mobile telephone of FIG. 1. executing the mobile payment application of FIG. 1.

FIG. 3 is a block diagram depicting the point of sale architecture of FIG. 1 and a capture event of a printed receipt according to an embodiment of the present invention.

FIG. 4 is an architectural diagram of an Email loop supporting electronic receipt capture according to another embodiment.

FIG. 5 is a process flow chart depicting steps for capturing and storing a receipt electronically according to one embodiment of the invention.

FIG. 6 is a process flow chart depicting steps for capturing and storing a receipt electronically according to another embodiment of the invention.

FIG. 7 is a sequence diagram depicting a semi-automated interaction sequence supporting voice characterization tagging of a captured receipt according to an embodiment of the present invention.

FIG. 8 is a block diagram depicting an email system and network loop for capturing and forwarding captured transaction receipts resulting from transactions executed at POS terminals or at retail Web interfaces.

FIG. 9 is a process flow chart depicting steps for receipt aggregation and characterization according to one embodiment of the invention.

FIG. 10 is an architectural view of a communications network supporting receipt capture via QR code according to an embodiment of the present invention.

FIG. 11A is an elevation view of a mobile phone displaying a receipt in the form of a scanned QR code.

FIG. 11B is an elevation view of the mobile phone of 11A displaying a receipt reconstructed from the QR code of 11A.

FIG. 12 is a process flow chart depicting steps for receipt capture and aggregation according to an embodiment of the present invention.

FIG. 13 is an architectural view of a communications network supporting automated receipt capture notification and activation via remote service.

FIG. 14 is a process flow chart depicting steps for remote notification of receipt capture and camera activation according to one aspect.

FIG. 15 is a process flow chart depicting steps for remote notification of receipt capture and camera activation according to another aspect.

### DETAILED DESCRIPTION OF THE INVENTION

In various embodiments described in enabling detail herein, the inventor provides a unique method for use in capturing electronic receipts resulting from transactions at a point of sale (POS) terminal or through a network retail Web interface. The present invention is described using the following examples, which may describe more than one relevant embodiment falling within the scope of the invention.

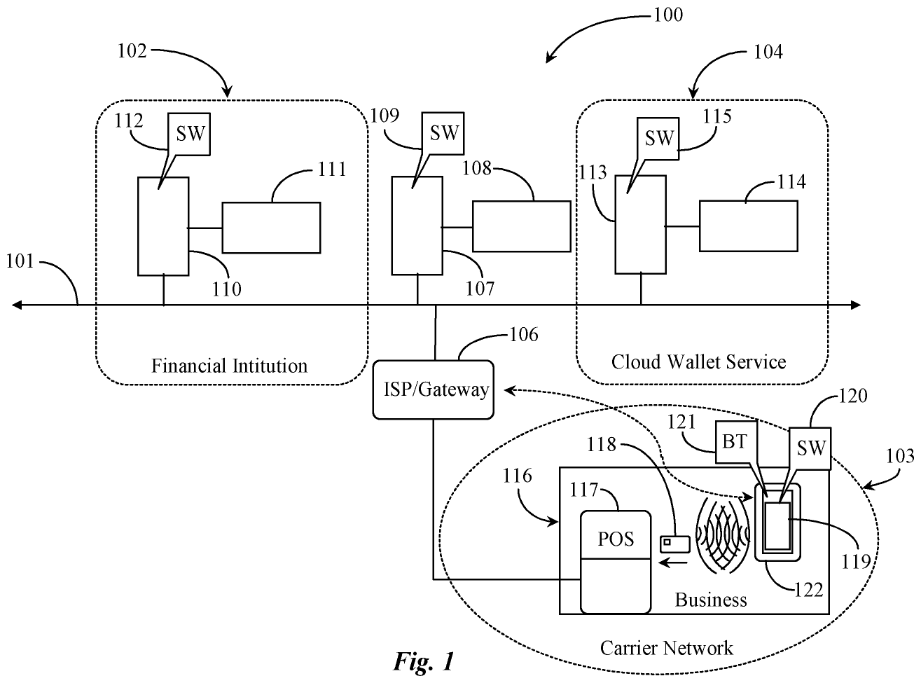

FIG. 1 is an architectural view of a communications network 100 that supports real-time electronic receipt capture and aggregation according to an embodiment of the present invention. Communications network 100 includes network backbone 101. Network backbone 101 may represent all lines, equipment, and access points routers and gateways that make up the network as a whole including connected sub networks. Communications network 100 may be an Internet network or another wide-area-network (WAN) without departing from the spirit and scope of the present invention. There are no geographic limits to the practice of the invention.

Backbone 101 supports a network cloud labeled cloud wallet service 104. Cloud wallet service 104 may be adapted by a financial mobile cloud wallet service company to store credit card data, debit card data, and other electronic card or account data, for a mobile user, represented herein as user phone 122 having a dynamic transaction card 118 that may be programed with a selected set of card transaction data, for example, to make a specific transaction. Cloud wallet service 104 includes a server 113 supported by back bone 101 running a software (SW) application 115 and coupled to a data repository 114. SW 115 may be a cloud wallet application for a dynamic transaction device like card 118 or another device used to interact with a sales or banking terminal (electronic machine/network node). Data repository 114 may include user identification and profile data, user accounts data, financial history data including transaction history, cloud wallet account data and the like.

Communications network 100 may include one or more financial institution domains 102 interfacing with a bank, credit union, or other financial account service site that may provide banking services to user 122 as a client. Domain 102 is a financial institution that may issue a financial transaction device to user 122 based on client status and account information. Financial institution 102 broadly represents entities that may be considered financial institutions with services used by user 122 like banks, credit unions, investment houses, etc. Financial institution 102 includes a server 110 supported by back bone 101. Server 110 hosts a software (SW) application 112 adapted to provide an electronic interface as a tool to user 122 for account use and management. SW 112 may include at least one component adapted to cooperate over a network with SW 115 running on server 113 in cloud wallet service domain 104.

Communications network 100 may include at least one network-based retailer selling products or services referenced herein by a server 107 supported by backbone 101, a software (SW) application 109 executing on server 107, and a data repository 108 coupled to server 107. Server 107 may represent any entity (network node) accessible to the user where a transaction may be performed. Data repository 108 may hold service and product related data, and user interaction and any transaction history user 122 has at the site.

Access to communications network backbone 101, which may represent the Internet in one embodiment, may be through an Internet service provider (ISP)/access Gateway 106 supported by backbone 101. A carrier network 103 is depicted that enables communications including wireless communications to be bridged onto communications network 100 through ISP Gateway 106. Carrier network may be a wireless 5G network or similar mobile network that user-operated mobile phone 122 may use to access the network and practice local and long-distance communications using the representative mobile telephone. Mobile telephone 122 may be Bluetooth™ enabled by hardware and software (SW) 121 labeled BT. Mobile phone 122 may host a software (SW) application 120 adapted as a thin mobile SW application including a network connection and browsing ability that may locally display information screens like screen 119 in display on mobile phone 122.

The user operating mobile phone 122 is at a business domain 116 that may be a service site, restaurant, retail establishment, parks service, or any venue that user 122 may enter to buy a product or service. In this embodiment, business 116 includes a point of sale (POS) machine or terminal 117 that takes, at least, credit and debit cards for satisfying financial transactions made by user 122. In this embodiment, user 122 has a dynamic universal transaction card 118 that may be electronically associated to a funding source account and may be accepted by terminal 117 to pay for goods or services. In a preferred embodiment, user 122 may transmit account data to card 118 from the mobile telephone while running SW 120 and SW 121 wherein the card 118 is Bluetooth™ enabled to at least receive the account data (card number) wherein the account data represents an account that user 122 has represented in cloud wallet service 104.

User 122 may have several different accounts represented in cloud network 104 and dynamic transaction card 118 may be loaded with any of the user's account data to use that account to pay for goods or services during a transaction. SW 120 on mobile phone 122 enables the user to interact with cloud network 104 just before using card 118 at POS terminal 117 so that the user may determine which of several accounts might be imprinted or sent to card 118 for use as a device representing that account.

Cloud wallet application screen 119 on mobile phone 122 may be part of the interactive interface available to the user operating mobile phone 122 to load card 118 with a card number, security code, and other pertinent data so the card may be used as a card of the selected account. Any new account data that the user loads onto card 118 may overwrite any previous account data on the card memory.

In a preferred embodiment, SW 115 executing on server 113 in cloud wallet service 104 is adapted to at least receive and file electronic receipts on behalf of the active user operating mobile phone 122 in near real time. Card 118 may be used as the transaction device to pay for one or more transactions at POS terminal 117, the card written to by mobile phone 122 executing application 119 in broad respect while card 118 represents a particular account listed in cloud wallet service 104.

In one embodiment, the user may capture a hard receipt (not illustrated) associated with any transaction initiated and completed with card 118 that is printed out in form by POS terminal 117 immediately after a transaction is performed. In one embodiment, the hard receipt associated with a transaction performed with card 118 may be captured by a camera/scan application (not illustrated) resident on mobile phone 122. SW 120 may include an extension of SW 120 to an application on mobile phone 122 like a camera application. A receipt capture may be a semi-automated sequence of events that are triggered by a transaction event having occurred.

In this embodiment, dynamic card 118 may be used to conduct a transaction that will produce a receipt and may be enabled for wireless communication. In one embodiment, dynamic card 118 may send at least a data notification, a push notification command, or signal over the wireless link to mobile phone 122, for example, by Bluetooth™ wireless network (bi-directional line patterns). For example, dynamic card 118 may communicate via Bluetooth™ or other wireless protocol to mobile phone 122, the data notification, command, or signal, verifying that a transaction has been completed at POS terminal 117 and a receipt is forthcoming.

The communication may, in one embodiment, function as a direct command to execute a camera application resident on mobile phone 122 using SW 120 and interface 119. In another embodiment, the communication may be a simple notification with sound, flash or other haptic feedback that may prompt the user operating mobile phone 122 via a pop-up or other visual notification appearing in screen 119 that a transaction has occurred and a receipt is forthcoming and may be electronically captured.

In one embodiment, paper receipts are printed at the POS terminal 117 after a transaction is conducted and wherein the dynamic card 118 communicates a signal triggered by the read operation at the POS terminal, the signal processed by the cloud wallet application causing a camera application, via application extension, to execute automatically on mobile phone 122 to ready the camera or scanning device to capture/scan the printed receipt including the last four digits of the account number, the date, time, name of business, and items, service descriptions, and any other important information printed on the receipt paper.

In one embodiment, POS terminal 117 does not print a hard receipt but displays an electronic receipt on a display screen after the transaction that the user operating mobile phone 122 may see and use the phone to capture the display by image capture or scanner before the electronic receipt is requested by the user to be delivered to mobile phone 122 by email.

Optical character recognition (OCR) may also be employed, for example, during scan to render the electronic receipt editable if desired as an option to allow another application to manipulate data on the receipt. For example, enabling copy of some receipt data but not the whole image, or redacting or otherwise hiding or obscuring some of the receipt data such as the merchant name for example.

In another embodiment, the user operating mobile phone 122, wherein the mobile phone and the POS terminal are enabled for near field communication (NFC), may be using the mobile phone without an intermediate transaction device to transfer the correct wallet account information at the POS NFC interface to conduct a transaction. In both of these embodiments, the mobile phone 122 may capture a hard receipt or an electronic receipt displayed on a POS screen.

In still another embodiment wherein the POS terminal is not connected to a printer and has no display capability, a receipt may be captured electronically from the user's email account or messaging account if the merchant electronically mails or otherwise propagates the receipt to an end device controlled by the user. SW 120 may in addition to having a SW extension or application programing interface (API) to the user's camera application and permission granted by the user to grant the applications use the camera application or scanning application on the user's mobile phone 122, have extensions and or APIs to the user's email and text messaging applications where a receipt from a transaction conducted at a merchant POS terminal.

In the above scenario, the cloud wallet application may monitor the user's email or messaging account and may grab or capture the receipt from a merchant as an attachment to the email or text message. In a variation of this embodiment, the wallet application may be further enhanced with a SW extension that allows the application to use a screen scraping utility or snap-shot utility to capture a receipt in display (but not attached) in an open email window on the user's mobile phone where the wallet application may be further enhanced with a capability to open email messages.

A stated goal of the invention mentioned above and in addition to capturing receipts is to also aggregate receipts from transactions conducted by the user wherein the receipt aggregation is performed by cloud wallet account SW 120 executing on the user's mobile phone 122. The application may redirect those receipts (upload) to the cloud storage repository 114 at the wallet account domain 104 for later retrieval by the user or by an agent working on behalf of the user in tax planning, accounting, credit counseling, or other like services where user receipts must be accounted for.

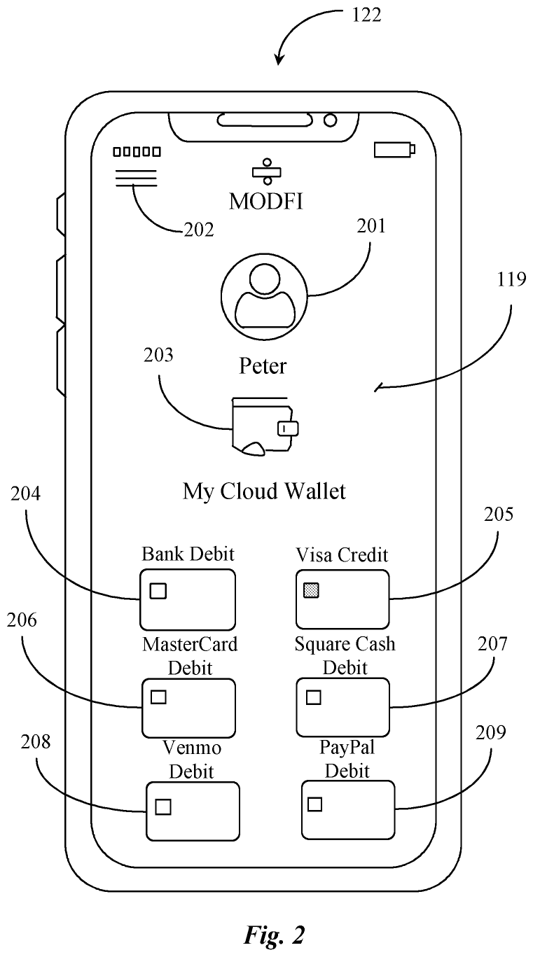

FIG. 2 is an elevation view of the mobile telephone of FIG. 1. executing the mobile payment application of FIG. 1. Mobile phone 122 has in display screen shot 119 depicting a cloud wallet account held by the user. In this embodiment, the account is a MODFI cloud wallet account known to the inventor and subscribed to by the user. However, any cloud wallet account or money payment application may be easily modified to practice transaction receipt capture and aggregation without departing from the spirit and scope of the invention.

Interface screen 119 includes a menu 202 of a variety of options that a user may invoke while using the application. The application is personalized to the user 201 and provides access to account data for all of the accounts that user 201 (Peter) has uploaded the information for in order to include the accounts as possible payment accounts that may be selected to fund initiated transactions. An icon 203 represents a folder or “wallet” listing all of the user accounts added to the service. Expanding wallet 203 may display several accounts separately for browsing, updating, or selection for a transaction. In this embodiment, accounts 204 through 209 are listed where 204 is a bank issued debit card account, 205 is a Visa issued credit card account, 206 is a MasterCard debit card account, 207 is a Square Cash debit card account, 208 is a Venmo debit card account, and 209 is a PayPal debit account.

User 201 may have in possession a dynamic transaction device like transaction card 118 of FIG. 1 and may using interface 119, select any one of accounts 204 through 209 to be assigned to the transaction device to use that account to fund any transaction as well as other tasks like using the dynamic card 118 loaded with any of the account data sets to access the account through an ATM terminal for example. In this embodiment, a user may select any one of accounts 204 through 209 and load that account data set onto the transaction device, for example, card 118 of FIG. 1, to perform a transaction with the card having the funds for the transaction deducted from the selected account.

The function of loading a dynamic card like card 118 of FIG. 1 with selected account data overwrites the existing account data on the card. A user may make more than one transaction with the transaction device loaded with a selected account and may overwrite the transaction device with any new account data (swapping accounts) making the next transaction associated with the next payment account data downloaded to the card. Using a transaction card with a writable memory is not required in order to practice the invention. A dedicated transaction device may be used provided the account on the card is represented in the client application and the electronic transaction record the card will be used to satisfy is accessible to the client application.

In one embodiment, receipt capture is a dynamic process occurring once at the relative moment in time of each transaction made. In one embodiment, the user may select the account desired for funding a next transaction and may capture a receipt upon evidence thereof at the POS terminal or interface.

In one embodiment, the user may click on any one of the listed accounts and mobile phone 122 may transmit an account data set from the selected account to the dynamic card (118), and may the receive a signal, command, or notification from the wireless card just after transacting with the POS terminal. The signal, command, or notification results in automatic execution through the cloud wallet client application of the camera application or feature thereof such as the imaging and/or scanning feature. The signal, command, or notification may include an audio beep or other sound or vibration to gain the attention of the user operating phone 122 if the user is not already focused on receipt capture.

The user operating phone 122 may typically have a copy of a bill digitally available to mobile phone 122 either by transmission thereto or by optically scanning the bill that documents the transaction details before the card is inserted or otherwise used and before a receipt is issued by the merchant after the card data is either approved by checking the source account identified on the card. This information may be propagated from the user's mobile phone or device 122 over the communications network to the cloud network to be associated with the actual transaction event (card insert/swipe).

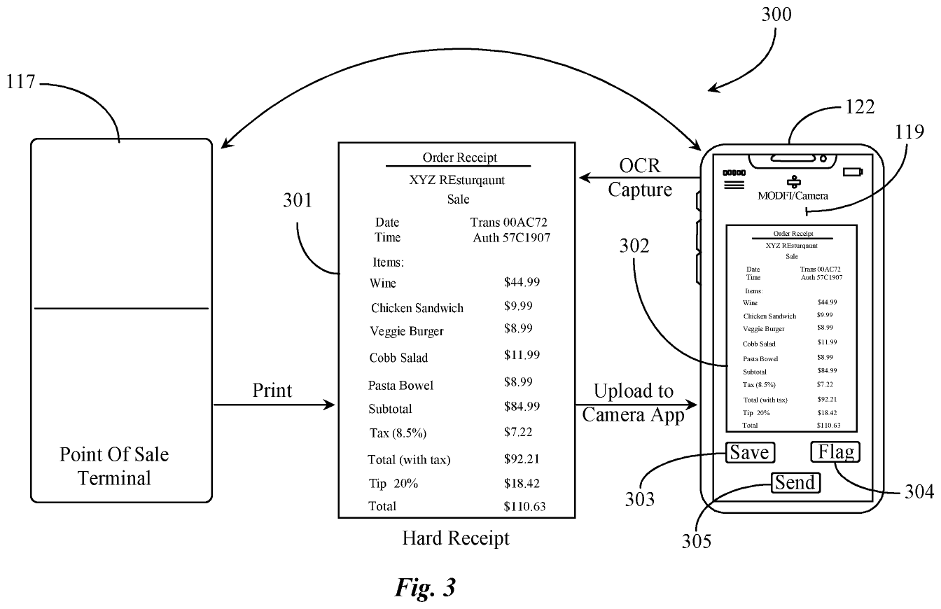

FIG. 3 is a block diagram depicting a receipt capture event of a receipt printed out by POS terminal 117 according to an embodiment of the present invention. POS terminal 117 is, in this embodiment, a POS terminal connected to a printing function and prints out a hard paper receipt referred to herein as receipt 301 after each transaction. Most In-person check-out counters offer this service. In this example, hard receipt 301 is a restaurant receipt including a date and time of the transaction, a transaction number, and an authorization number. The hard receipt lists the items purchased and the broken-down costs of each item, the percentage of sales tax, the tip amount, and the totals with tax and before tip and the grand total of the bill paid.

Receipt 301 may result from a dynamic card transaction like with dynamic card 118 or a mobile phone NFC transaction by mobile phone 122. In a case of transacting with a dynamic card like card 118 described above or perhaps another Bluetooth™ enabled transaction device that may be adapted to work with the cloud wallet application on phone 122, a signal, command, or notification may be communicated from the transaction device to the mobile phone as the card is being read. The signal, command, or notification may be received at phone 122 by application screen 119. Upon receipt of the communication, the application may execute the camera and scanning application feature used to capture hard receipt 301. In this way the user does not have to remember to capture the receipt once it is printed. The signal may be a text of the receipt at phone 122.

The automated execution of the capture features of the user's camera application may include a vibration or notification sound so the user will feel or hear it and take the task of positioning the capture hardware to capture or scan the receipt. Once the hard receipt 301 is captured and is on mobile phone 122, the image of the receipt may be displayed as receipt image 302 on application screen 119. In this embodiment, the user may select to save the receipt by selecting a save function 303. This function may save the receipt to a specific folder on mobile phone 122. In one embodiment, the user may also categorize captured receipt 302 as a wholly or partly tax-deductible receipt by selecting a flagging option 304. The user may also select a send option 305 that, if selected communicates the electronic receipt copy 302 to the cloud wallet service for processing and storage.

It is noted herein the image capture feature used in the camera application captures the receipt and uploads it to the cloud wallet screen 119 on mobile phone 122 as electronic image or OCR'd document 302. In one embodiment, receipt 302 is a static image and cannot be manipulated by software and is stored as an image file at the cloud wallet service. In another embodiment, captured and displayed receipt 302 is an electronic document manipulate-able by SW 120 on mobile phone 122. A user may be enabled to redact a portion of the receipt or even recalculate what the user has actually paid considering the possibility of a receipt that might be the result of a shared transaction where the user was reimbursed for another user or user's shares of the bill.

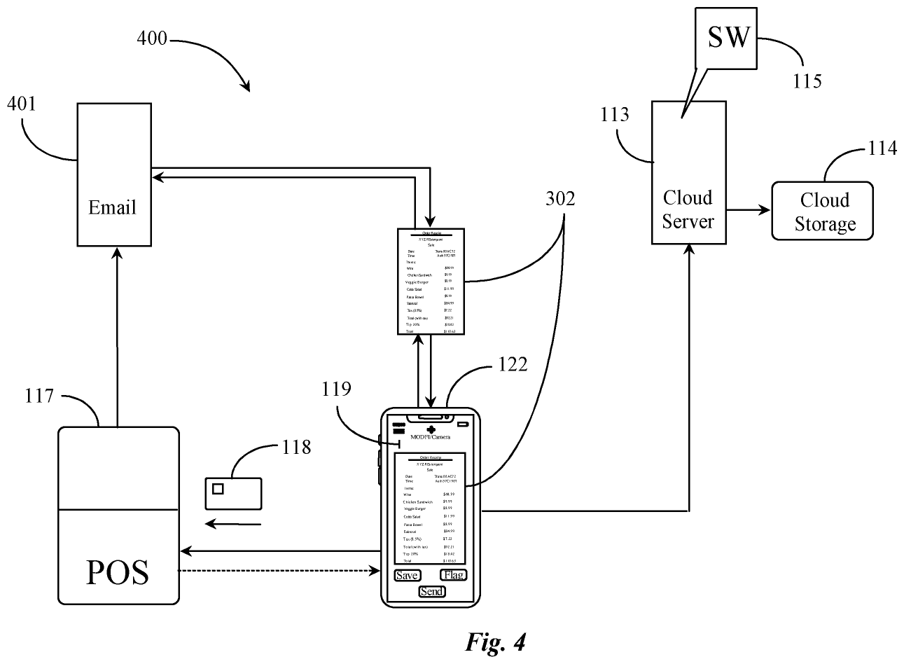

FIG. 4 is an architectural diagram of an Email loop 400 supporting electronic receipt capture according to another embodiment. In this example, POS terminal 117 does not print out hard receipts that the user might capture using mobile phone 122. Therefore, it is assumed in this embodiment that the merchant has the email address or phone number of the user. In one embodiment, the user may give the person the correct email address at the time of the transaction if the merchant does not already have the address in the system.

In this embodiment, the user operating mobile phone 122 has application screen 119 running when he or she initiates a transaction at POS terminal 117 using dynamic card 118. At the time of transaction when the card is read and approved for the transaction amount, POS terminal sends an electronic receipt to the user's email or text account referenced herein as email server 401. Card 118 may include Bluetooth™ enablement and a micro controller unit (MCU) on board and sends a signal, command, or notification via Bluetooth™ to mobile phone 122 that is received by application screen 119.

Application 120 may include an extension to automatically open the user's email or text account to retrieve email. The email feature of the user's email account may log into email server 401 and retrieve the email from the merchant that includes the attached or embedded email receipt 302. In this embodiment, the email attachment or embedded receipt 302 displays in application screen 119. The application may upload receipt 302 to cloud server 113 aided by SW 115 and the cloud wallet service may archive the receipt for the user in cloud data storage 114.

It may be noted that a number of tasks may be performed relative to receipt 302 by the user operating SW 120 on mobile phone 122. The receipt might be flagged as a tax deduction, flagged for reimbursement, checked for correct math and corrected as for total amount (if incorrect), marked as a shared transaction where the user may append the receipt to include the user's actual amount paid.(shared transaction), or redacted in portion by the user. In a preferred embodiment, receipt 302 is processed in a semi-automated manner so that the user may not forget about the receipt and have to find it again at tax time.

The semi-automation during transaction and upload to the cloud wallet service ensures that the receipt is aggregated and not left out or forgotten by the user. The signal command or notification made from card 118 ensures the user will at least be aware that the receipt is available and may be immediately aggregated and stored. The cloud wallet service (104, FIG. 1) may archive receipts like receipt 302 according to the accounts sourced to pay for the transactions.

In one embodiment, receipts that are archived in separate account activity histories may be retrieved according to receipt category. For example, a user operating mobile phone through application screen 119 might retrieve all receipts that were fuel and toll related that may be travel expenses though the receipts are archived by the cloud wallet accounts that funded the transactions producing those receipts. Receipts that are printed and captured or captured electronically are aggregated and are retrievable by the user or agent working on behalf of the user like a tax preparer or a certified public accountant (CPA). In one embodiment, a user may simply capture a receipt that is hand written, or one that resulted from a transaction where cash was used to pay a bill and may upload that receipt to the cloud wallet service if the user has reason to like the transaction being tax deductible.

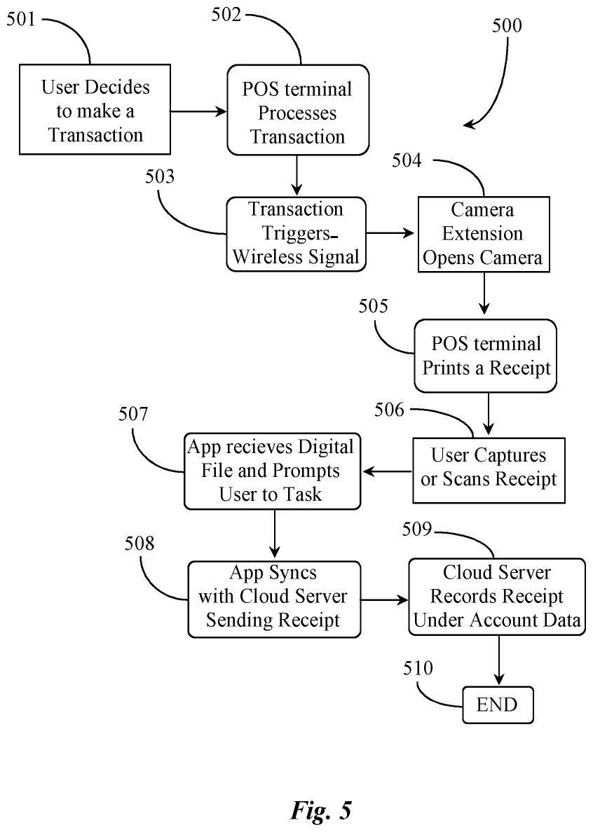

FIG. 5 is a process flow chart 500 depicting steps for capturing and storing a receipt electronically according to one embodiment of the invention. At step 501, a user operating mobile phone 122 as a transaction device or as a parent to a transaction device like dynamic card 118 of FIG. 1 initiates a transaction at a POS terminal. At step 502, the POS terminal processes the transaction. At step 503, the transaction event (card read/approval) is detected by the transaction device, in this case, a dynamic card analogous to card 118 of FIG. 1. Card 118 sends a wireless signal, command, or notification in step 503 that may cause the user's camera or scanning application features to open in step 504 in association to SW 120 and screen 119.

At step 505, the POS terminal 117 may print a hard paper receipt. The user, having received signal notification or direct command, captures, or scans the receipt at step 506. In this step the signal, notification or command executes the camera or scan feature through the screen. The signal, notification, or command may include audio alert or vibration sequence, so the user does not miss the opportunity to use the executed feature to capture the receipt by imaging or scanning, the receipt uploaded to the user's mobile device.

At step 507, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 508, the application may synchronize with a cloud wallet server analogous to server 113 of FIG. 1 aided by SW 115 and may send the now electronic receipt to the cloud wallet service for archiving on behalf of the user. At step 509, the wallet service may record the receipt under the account data for that receipt or in the activity log for the wallet account that funded the transaction. The process may end at step 510. It is noted herein that the user may through the client application, connect to the wallet service and review receipts, retrieve receipts, search for specific receipts by category, or by date, and so on.

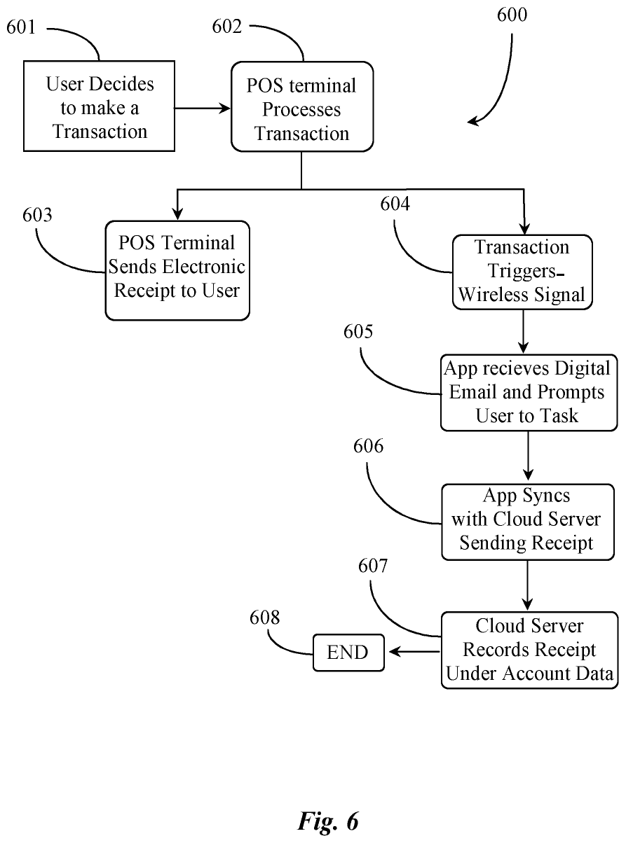

FIG. 6 is a process flow chart 600 depicting steps for capturing and storing a receipt electronically according to another embodiment of the invention. At step 601, a user operating mobile phone 122 as a transaction device or as a parent to a transaction device like dynamic card 118 of FIG. 1 initiates a transaction at a POS terminal. At step 602, the POS terminal processes the transaction. The transaction event (card read/approval) is detected by the transaction device, in this case, a dynamic card analogous to card 118 of FIG. 1. At step 603, the POS terminal analogous to terminal 117 of FIG. 1 sends an electronic receipt to the user, typically via text or email account known to the merchant and wherein the email was provided by the user at some point in the past or is provided during the transaction.

At step 604, card 118 sends a wireless signal, command, or notification that may cause the user's email request feature to execute and open in association to SW 120 and screen 119. In this step the signal, notification or command executes the email request feature through the screen. The signal, notification, or command may include a text, audio alert or vibration sequence, so the user does not miss the opportunity to use the executed feature to capture the receipt by downloading the receipt to the user's mobile device.

At step 605, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 606, the application may synchronize with a cloud wallet server analogous to server 113 of FIG. 1 aided by SW 115 and may send the now electronic receipt to the cloud wallet service for archiving on behalf of the user. At step 607, the wallet service may record the receipt under the account data for that receipt or in the activity log for the wallet account that funded the transaction. The process may end at step 607. It is noted herein that a user may skip, or override receipt capture as detailed in processes of FIG. 5 and of FIG. 6 if that user does not wish to save a receipt for a transaction. In one aspect of both processes, a user may configure transaction accounts in the cloud wallet service to require receipt capture whenever that particular account or accounts are used.

In one possible embodiment, a dynamic card enabled for Bluetooth™ and having a writable memory may receive an electronic image from the POS if the POS is enabled to write such as image to the card. The dynamic card may, in that case, send the electronic receipt back to the mobile phone over the wireless connection. In still a further embodiment, the dynamic card may have a screen scrape application provided in available memory allocated for the purpose and may copy an image of the receipt displayed in a display screen on the POS terminal, however, a POS terminal would have to be modified with an electronic access or read path from the card slot interface directly to the display screen.

The just described embodiment may not be preferred for security reasons that the card may capture a different receipt image but electronically it is possible for a device having an MCU and a thin firmware executable on the card to capture the contents of the POS screen. In that case, the card may immediately communicate the captured image to the mobile phone or may transfer the image, for example, when docked with the phone as is known to the inventor for one type of dynamic transaction card.

### Voice Enabled Tagging and Receipt Characterization

In one embodiment of the invention, a user may voice-tag a captured receipt using voice to text capability on the user's mobile telephone analogous to phone 122 of FIG. 1 aided by SW 120.

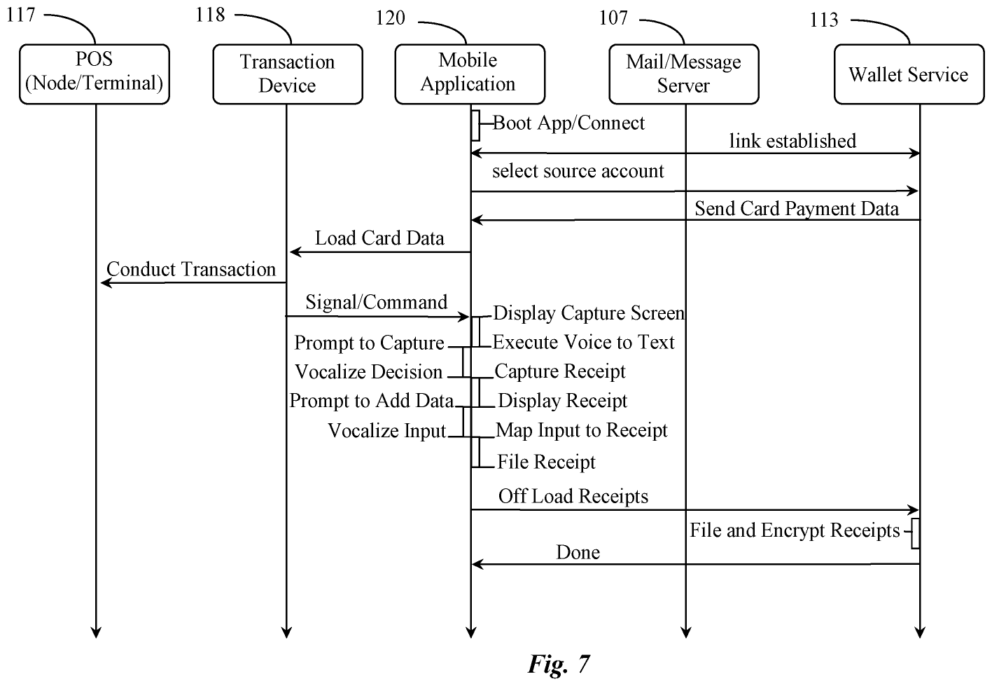

FIG. 7 is a sequence diagram depicting a semi-automated interaction sequence supporting voice characterization tagging of a captured receipt according to an embodiment of the present invention. A user operating a mobile telephone and using a transaction device or the phone itself as a transaction device can interact with any point of sale (POS) terminal or node to effect receipt capture as described further above.

Before engaging with a POS terminal to transact through the terminal, the user executes or boots a wallet application 120 resident on the mobile telephone or other mobile device having connection to a cloud wallet service or other network-based money payment SW service.

A working network connection is then established over the network with a network server 113, referred to herein as wallet server 113. As described further above, this enables the user to select a source account to cover for a transaction, for example, when using a dynamic writable transaction card or other writable transaction device.

Wallet server 113 sends the requested card data in encrypted format to the user, typically to the user's mobile device running the wallet application 120. The user may receive the card data in the wallet application and may send that card data to a transaction device like device 118 (dynamic card) via a wireless communications protocol like Bluetooth™. The card data communicated to the card overwrites and other card data that was on the card. Thus, the user loads the card data received from server 113 onto dynamic smart card 118 prior to initiating a transaction at terminal 117.

The user may then use card 118 to conduct the transaction wherein POS terminal 117 reads the loaded card data from a magnetic stripe or reader interface when the card is inserted. At the time reading occurs, a signal push notification or command is sent back to the user's mobile phone to cause the wallet application to execute one or more features in other resident applications that may be useful in receipt capture. In one embodiment, the wallet executes a voice input feature like a microphone application feature which enables the user to speak into a microphone on the mobile telephone. The mic feature enabling voice to text (VTT) may be executed automatically via a SW extension provided in SW 120 from inside the application on user's microphone.

If wallet application 120 is not running on the phone then the signal, command, or push notification may be received by a watch extension and used to open SW 120, which in turn may immediately execute other appropriate features resident in other applications on the phone. More particularly, the signal command or notification may result in a display of a receipt capture screen analogous to screen 119 of FIG. 1, while executing a voice to text feature or an audio recording resident on the mobile phone.

A first prompt to the user may appear on screen asking if the user wishes to capture the forthcoming receipt for the instant transaction. The prompt may be a simple phrase Capture Receipt, Followed by a yes and a no touch screen option. If the user wishes, the user may say yes or no into the microphone to continue with the process. If the user declines, the sequence ends because the user is not interested in that particular receipt. In the event the user wishes to capture the receipt, the user may vocalize that decision by saying yes or touching the yes option on screen.

The application 120 may, as a result of a yes answer, execute the receipt capture feature via SW extension and user permission. The user may then capture the receipt using on or another executed feature. In one aspect of this sequence more than one capture feature might be offered like a camera imaging feature, a message retrieval feature, or a scan feature using optical character recognition (OCR). Once the receipt has been captured, it is immediately displayed on the application screen 119 so the user may visualize the receipt and in some cases manipulate the receipt according to options provided like redaction, enlarge, crop, etc. that may be provided in a pane on the capture screen showing the receipt.

Once a user is satisfied with the receipt in display, the user may save the receipt in its current form and a prompt may appear asking the user if the user wants to add any characterization data to the receipt. The receipt has information that helps categorize it and that information may be used in archiving etc. However, the user may want to describe a business situation including names of parties to a transaction etc. depending upon the type of transaction.

Rather than manually typing data into a screen dialog box from a small key pad typical of a mobile phone, the user may use the voice to text feature or make a voice recording to input characterizations about the receipt including any details the user cares to vocalize. In one embodiment, the user makes a recording, and that recording is saved as an audio recording and transcribed later and associated with the receipt. In another embodiment, the user vocalizes characterizations that appear as typed text in a voice to text scenario wherein the text is associated or tagged to the receipt.

Either input type such as audio recording or voice to text input is mapped or linked to the receipt on the user's mobile device. After the user has finished characterizing the receipt, the user may hit save or done in the screen and the application may file the receipt for later upload or offload onto another device or to the cloud wallet service 104 introduced in FIG. 1 above. Any time after the transaction, the user may upload the receipt and the associated data and or media to server 113 at the cloud wallet service 104. Once in house, the SW 115 running on the server may transcribe audio attached to the receipt and create a text record as well as save the audio if the user prefers. The receipt and audio, text characterization files may be stored together according to user metrics or a user-created file system.

In one embodiment, the wallet service files the receipts and associated data or media under the activity histories of the accounts that were used to cover the transactions. In some embodiments, a user may create a single archive containing all of the receipts, data and media associated therewith. In this embodiment, the receipts may be searched according to any of the metrics on the receipts including account source and any data metrics provided by the user in receipt categorization. The features residing on the user's mobile phone may be resident features of other applications that are tied to application 120 through an extension such that they may be borrowed as application features of application 120.

The exact method used to capture the receipt initially may be any of the features previously described above. A user may also say no to receipt characterization using voice and instead operate with standard receipt categorizations offered as interactive options in the application screen 119 such as gas receipt, business trip hotel receipt, car rental receipt business trip, etc. Once the user has the electronic version of a receipt captured, the user may practice the categorization and characterization methods while connected to server 113 or while offline.

### Automated Aggregation of Electronic Receipts

In one embodiment of the invention, a user may provide a dedicated email address to aggregate receipts for forwarding to a central location in a cloud service where they may be sorted and made available to users operating a network device with an application to access those receipts and tools to characterize, flag, and manipulate certain receipt data and provide meta data about those receipts.

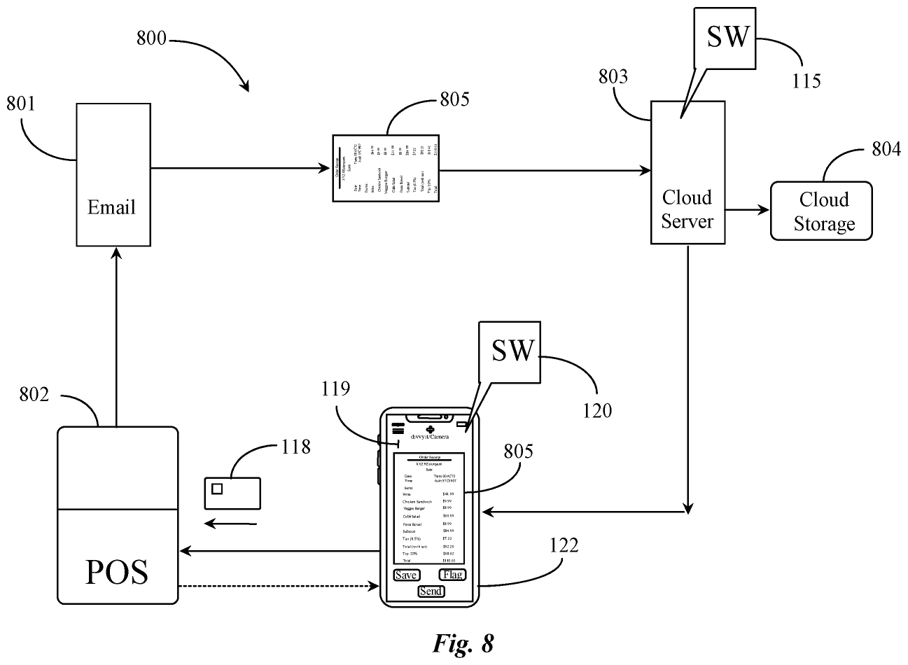

FIG. 8 is a block diagram depicting an email system and network loop 800 for capturing and forwarding captured transaction receipts resulting from transactions executed at POS terminals or at retail Web interfaces. Network loop 800 refers to a data network loop or path involving a point of sale (POS) terminal or network node 802 having at least a network connection to an email server 801, which has direct network path access to a cloud server 803 with access to cloud storage 804, the server aided by SW application 115 whereby the cloud server/SW and email domain are part of a cloud wallet service subscribed to by the user.

A user operating mobile phone 122 aided by SW 120 (thin download-able client app. of SW 115) depicting application screen 119 may execute a transaction for goods or services at POS terminal 802 using a, for example, universal smart card 118 with writable memory for excepting card data from the user's cloud wallet service via a wireless transmission from the mobile device 122 to the card 118.

In many cases of retail, the user may shop regularly and may already have an email address on record with the merchant operating the POS terminal. In a preferred embodiment, the user's cloud service provides an email aggregation service and may issue a special unique email address to the user. The email address is a dedicated email address for receiving and forwarding at least the electronic receipts resulting from transaction approvals obtained by the POS terminal or transaction debit acceptance events at the POS terminal for a credit card.

A user may provide the receipt aggregation (RA) email address to any merchant as part of a membership to the merchant site or simply as a contact email address the merchant will keep on file for future interaction. POS terminal 802 may generate a receipt 805 for a transaction handled with card 118 and may send a copy of the receipt to the user's provided email address. Email server 801 may be a dedicated and controlled server operated by the cloud wallet service as architectural feature support for the service. Email server 801 may be programmed as a mail stop for user receipts that are as soon as received, forwarded to cloud server 803 aided by SW 115.

In this way, the user operating mobile phone 122 does not have to pay attention to the receipt 805 or remember to access the receipt. Once the receipt 805 is at cloud server 803, email source identifies the user and security may be maintained within a single domain. Cloud server 803 running SW 115 may use available knowledge about the user and recent user activity to sort the receipts or map the receipts to a credit or debit account maintained at the cloud service hosting server 803.

When receipt 805 is archived in repository 804 (cloud storage), server 803 may push a notification to mobile phone 122 informing the user the receipt 805 is accessible to the user for review, tax flagging, or other possible tasks that the user may perform to the electronic receipt file through application screen 119 of SW 120 (receipt 805 depicted on screen 119).

In one embodiment, aggregated receipts may be sorted, categorized, and filed on behalf of users at cloud server 803 connected to repository 804 before the service sends a push notification to application 120 running on mobile phone 122 that a receipt (805) is processed and available for user access through application 120 for display in screen 119. In this embodiment, the user may follow a link in the notification or click on the notification to view the receipt through application 120 and have access to tools for performing tasks relative to the receipt.

In one embodiment, a user operating mobile phone 122 may access email server 801 as an Internet Email Access Protocol (IMAP) client to view captured receipts as aggregated on server 801. In one embodiment, a user may subscribe to the dedicated email service and use the email service for correspondence (sending and receiving email) like any other email account. In this case receipts may be isolated to one sub-folder of a general in-box where the receipts may be found.

One useful aspect of keeping receipts in an isolated email folder is convenience to the user in accessing the folder for view and refresh. The timestamps on the emails in the receipt in box closely correlate with the date and time of transaction at the merchant POS terminal 802. In an alternate embodiment, the email system is dedicated to receiving receipts from any transaction the user makes where the POS terminal or network node that generates the receipt on behalf of the merchant emails the receipt to the email address of the user. In this embodiment, the receipts are aggregated and forwarded to the cloud service where there may be no direct records left of the receipts on the server rather just the email bodies that delivered them. In a typical use embodiment, the cloud service may notify a user of receipt accessibility through the mobile application running on mobile phone 122. In one embodiment the service issues temporary emails to users who have selected cloud wallet accounts to transact using a dynamic card. In this case, the email is temporary and is only provided to aggregate the receipts from transactions made using one account. After the user selects another account a new email is generated and sent to the user along with the card account data. The user may submit the temporary email address to the merchant through the POS interface or terminal using a wireless card or by typing the information into a web interface.

In one embodiment, the cloud wallet service generates a new and unique email address for a subscriber for the purpose of capturing receipts and associates that email address, which is a temporary address to the account that the subscriber is using to conduct the transaction(s). In this embodiment, the POS may receive the temporary email address during the transaction and may automatically send the electronic receipt to that email address. In this way, no data is saved after aggregation of the receipts and when the subscriber selects a new account to use for new transaction(s) a new email address is generated for the purpose.

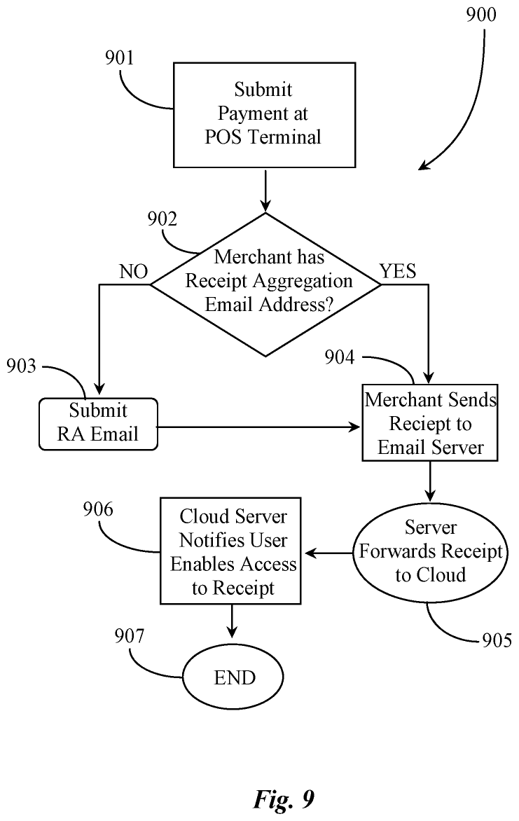

FIG. 9 is a process flow chart depicting steps 900 for receipt aggregation and characterization according to one embodiment of the invention. At step 901, a user may submit payment using a payment card or transaction device at a POS terminal hosting a transaction. In one embodiment, the POS terminal is a Web interface and the transaction falls into a category of an online or network transaction. At step 902 a determination is made whether the merchant has the user's RA email address. The RA email address may be known to the merchant already. In another aspect the user must give the merchant the email address during the transaction.

If at step 902, the merchant does not have the email address, the user may update the merchant files with the RA email address at step 903. As with all email addresses, the user's name or handle may be part of the address and the domain may be the second part or last part of the address, for example, peter22@cloudwallet.com, for example. The address is special because it is dedicated at least in part to aggregate all of the user's electronic receipts that are sent to the email address. If at step 902 the merchant has the address or after the user has submitted it to the merchant at step 903, the process moves to step 904 where the merchant sends the receipt for the transaction directly to the RA email address.

At step 905, the email server may immediately forward the transaction receipts on to the cloud wallet service for processing. In one embodiment, an RA email address may be substituted for the user's normal correspondence email address relative to any merchants that are routinely patronized by the user. In a variation of this embodiment, the RA email address may be a temporary address that only works for the current round of transaction. If the user is a new client, the user may submit the RA email address to the merchant on the first transaction. It may be noted herein that SW controlling the handling of user email directs all merchant receipts received at the server to be aggregated, such as in a single in box folder and then forwarded to the cloud server for processing. This does not preclude any other important emails from being processed by the RA email domain. More particularly the user may use the RA email address for normal IMAP email correspondence.

The SW 115 of FIG. 1 may include the email domain service for users and the email server may be a dedicated server in the domain of the cloud wallet service. The SW may identify electronic receipts from transactions by recognizing various bits of information that appear in the receipt data. For example, the receipts include date and time of a transaction, a merchant name or logo, an POS terminal address, Geo-location of the transaction, and the last four digits of an account used to pay for the transaction.

The email logic may in one embodiment isolate all of the incoming messages containing receipts attached including those with embedded receipts from emails coming into the server for a client and may store the emails containing receipts for the SW to mine for the receipt data. The receipt data may be sorted categorized and archived the user, the receipts accessible as part of account history. In one aspect the email server and cloud server are on the same network server.

Once the emails containing the receipts are prepossessed and archived at the cloud server, the cloud server may notify the user over the network that a receipt or receipts are available for review and access at step 906. Notification may be received by the thin client application 120 running on the user's mobile phone. In that event, the user may click on the notification and download a receipt for review in screen 119 and may have access to tools for further describing a receipt, flagging a receipt for tax deduction, and so on. A user operating mobile phone 122 aided by SW 120 may access any electronic receipt from the cloud service at any time. The process may end at step 907.

In a preferred embodiment of the invention, the RA email system is a dedicated system contained entirely within the domain of the cloud wallet service. However, in one embodiment SW may be provided to users to modify existing email capabilities of an IMAP account or desktop versions of well-known programs like Outlook Microsoft, Google, and so on to add the function of identifying electronic receipts resulting from transactions made by the user and isolating those from other emails and forwarding those on the cloud service. In this way, the user does not have to worry about losing, misplacing, or not having immediate access to any electronic receipts the user has made that were aggregated by the system.

Receipt Aggregation from QR Code Capture

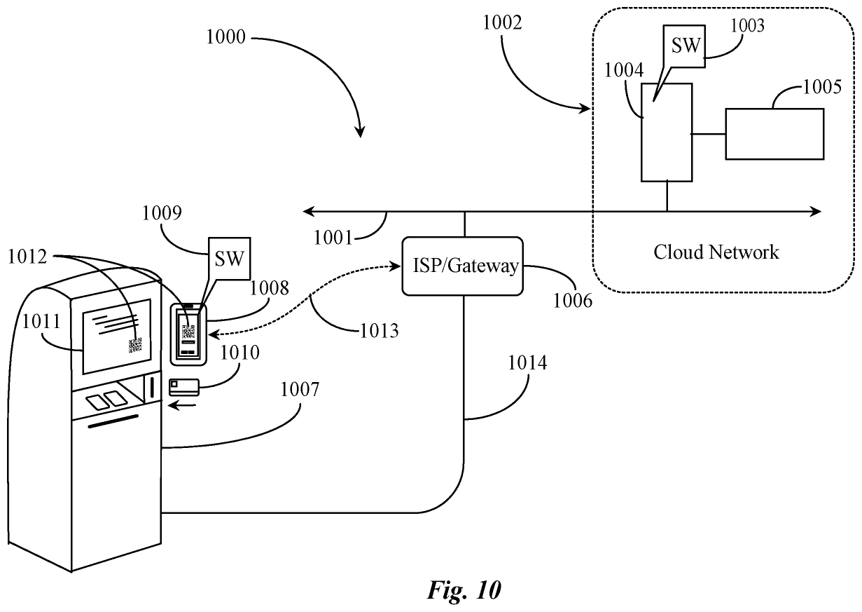

FIG. 10 is an architectural view 1000 of a communications network supporting receipt capture and aggregation via quick response (QR) code according to an embodiment of the present invention. Communications network 1000 includes network backbone 1001. Network backbone 101 may represent all lines, equipment, and access points routers and gateways that make up the network as a whole including connected sub networks. Communications network 1000 may be an Internet network or another wide-area-network (WAN) without departing from the spirit and scope of the present invention. There are no geographic limits to the practice of the invention.

Backbone 1001 supports a network cloud labeled cloud wallet service 1002. Cloud wallet service 1002 may be adapted by a financial mobile cloud wallet service company to store credit card data, debit card data, and other electronic card or account data, for a mobile user, represented herein as user phone 1008 having a dynamic transaction card 1010 that may be programed with a selected set of card transaction data, for example, to make a specific transaction.

Cloud wallet service 1002 includes a server 1004 supported by back bone 1001 running a software (SW) application 1009 and coupled to a data repository 1005. SW 1009 may be a cloud wallet application for a dynamic transaction device like card 1010 or another device used to interact with a sales or banking terminal (electronic machine/network node). Data repository 1005 may include user identification and profile data, user accounts data, financial history data including transaction history, cloud wallet account data, and the like.

Access to communications network backbone 1001, which may represent the Internet in one embodiment, may be through an Internet service provider (ISP)/access Gateway 1006 supported by backbone 1001. A carrier network is depicted as a dotted line 1013 between ISP/Gateway 1006 that enables communications including wireless communications to be bridged onto communications network 1000 through ISP Gateway 1006 and mobile phone 1008 running a software application (SW) 1009.

Carrier network may be a wireless 5G network or similar mobile network that user-operated mobile phone 1008 may use to access the network and practice local and long-distance communications using the representative mobile telephone. Mobile telephone 1008 may be Bluetooth™ enabled. SW application 1009 may be adapted as a thin mobile SW application including a network connection and browsing ability that may locally display information screens in display on mobile phone 1008.

The user operating mobile phone 1008 may be present at a business domain that may be a service site, restaurant, retail establishment, parks service, rental agency, lodging, or any venue that a user may patronize to buy a product or service. In this embodiment, a point of sale (POS) machine or terminal 1007 that takes, at least, credit and debit cards for satisfying financial transactions made by a user operating mobile phone 1008.

In this embodiment, a user operating mobile phone 1008 may have a dynamic universal transaction card 1010 that may be electronically associated to a funding source account and may be accepted by terminal 1007 to pay for goods or services. In a preferred embodiment, user operating mobile phone 1008 may transmit account data to card 1010 from the mobile telephone while running SW 1009 and Bluetooth™ wherein the card 1010 is Bluetooth™ enabled to at least receive the account data (card number) wherein the account data represents an account that user operating mobile phone 1008 has subscribed to as represented in cloud wallet service 1002.

It is noted herein that the components described above are the same or similar to counterparts described further above in FIG. 1 relative to architecture for receipt capture in general. Some components of FIG. 1 such as online retail and financial institution architecture are not described herein but may be assumed present in most embodiments without departing from the spirit and scope of the invention.

A user operating mobile phone 1008 may have several different accounts represented in cloud network 1002 and dynamic transaction card 1010 may be loaded with any of the user's account data to use that account to pay for goods or services during a transaction. SW 1009 on mobile phone 1008 enables the user to interact with cloud network 1002 just before using card 1010 at POS terminal 1007 so that the user may determine which of several accounts might be imprinted or sent to card 1010 for use as a device representing that account.

Cloud wallet application SW 1009 may embody information display screens on mobile phone 1008 that may be part of the interactive interface available to the user operating mobile phone 1008 to load card 1010 with a card number, security code, and other pertinent data so the card may be used as a card of a selected account. Any new account data that the user loads onto card 1010 may overwrite any previous account data on the card memory.

In a preferred embodiment, SW 1003 executing on server 1004 in cloud wallet service 1002 is adapted to at least receive and file electronic receipts on behalf of the active user operating mobile phone 1008 in near real time. Card 1010 may be used as the transaction device to pay for one or more transactions at POS terminal 1007, the card written to by mobile phone 1008 executing application 1009 in broad respect while card 1010 represents a particular account listed in cloud wallet service 1002.

In one embodiment, a user operating mobile phone 1008 aided by SW 1009 may capture a quick response (QR) code 1012 generated by POS terminal 1007. In this embodiment, the POS terminal generates a receipt in the form-package of a QR-based or derived code 1012 (code variations exist) that may be displayed on a POS screen 1011 in view of the user. In this embodiment, QR code 1012 is displayed on the application screen of mobile phone 1008 after it has been captured using a QR code scanner/reader native to the mobile phone. SW 1009 leverages the camera scanning capability of phone 1008 to enable QR code capture from screen 1011 or from a printed element (not illustrated) like a contract, an advertisement, or other content-printed paper.

SW 1009 may include a SW extension to an application on mobile phone 1008 like a QR scan capable camera application. In one embodiment, QR code 1012 is a dedicated vehicle for carrying only transaction receipt data. In one embodiment, QR code 1012 may include other data along with transactional receipt data like advertisement data, shipping data, product tracking information, product insurance, registration data, rental agreement data, or other contractual data.

In one embodiment, dynamic card 1008 may be used to conduct a transaction that will produce a receipt generated in the form of QR code 1012. In one embodiment, dynamic card 1012 may send at least a wireless data notification, a push notification command, or signal over the wireless link to mobile phone 1008, for example, by Bluetooth™ wireless network. For example, dynamic card 1008 may communicate via Bluetooth™ or other wireless protocol to mobile phone 1008, the data notification, command, or signal, verifying that a transaction has been completed at POS terminal 1007 and a QR receipt is forthcoming, for example, in display on the POS.

Moreover, the communication may, in one embodiment, function as a direct command to execute a camera application QR scanning feature resident on mobile phone 1008 using SW 1009. In another embodiment, the communication may be a simple notification with sound, flash or other feedback that may prompt the user operating mobile phone 1008 via a pop-up or other visual notification appearing in application screen that a transaction has occurred and a QR receipt like QR code 1012 is forthcoming and may be electronically captured.

In one embodiment, QR code 1012 is generated at POS terminal 1007 after a transaction is conducted and wherein the dynamic card 1008 communicates a signal triggered by the read operation at the POS terminal, the signal processed by the cloud wallet application causing a camera application, via application extension, to execute automatically on mobile phone 1008 to ready the camera or QR code scanning device to capture/scan QR code 1012 as it is displayed on screen 1011 of POS terminal 1007.

A QR code reader may be employed, for example, during QR scan to render the electronic receipt legible and, in one embodiment, somewhat editable in display on screen 1011. In another embodiment, the user operating mobile phone 1008, wherein the mobile phone and the POS terminal are enabled for near field communication (NFC), may be using the mobile phone without an intermediate transaction device to transfer the correct wallet account information at the POS NFC interface to conduct a transaction. In this embodiment, the generated QR code 1012 carrying receipt data may be transferred through NFC to mobile phone 1008 without departing from the spirit and scope of the invention.

In still another embodiment wherein the POS terminal 1007 is not connected to a printer and has no display capability, a QR code carrying receipt data may be captured electronically from a user's email account or messaging account (display enabled) if the merchant electronically mails media or graphics or text to an end device controlled by the user.

In the above scenario, the cloud wallet application may monitor the user's email or messaging account and may grab or capture the QR code 1012 generated and sent by a merchant as an attachment to the email or text message. In a variation of this embodiment, the wallet application may be further enhanced with a SW extension that allows the application to use a screen scraping utility or snap-shot utility to capture a QR code embedded in display (but not attached) in an open email window on the user's mobile phone where the wallet application may be further enhanced with a capability to open email messages.

In this architecture, a user operating mobile phone 1008 may capture and read QR code 1012 and may display the data in template form on the application screen while running SW 1009. The template form may include spaces for all pertinent data for a type of transaction receipt. In one embodiment, there may be multiple template types available to a QR reader to accommodate different types of receipts, for example, a product receipt or a service or rental receipt. In another embodiment, accompanying important documents may also be included with the transactional receipt data like service contracts, rental agreements, operational instructions, registration forms/links and the like.

In one aspect of the invention a user operating mobile phone 1008 may capture QR code 1012 from POS screen 1011 onto mobile phone 1008 running application 1009. Once on the mobile phone, QR code 1012 may be first displayed as a machine-readable code or not otherwise altered. The application may provide in this aspect, an option to the user to reconstruct the QR data into human readable form. The user may reconstruct the image in a somewhat editable format wherein tools like redaction features erase or mask might be available as well as tools for adding any meta data or digital associations with the reconstructed receipt data. The user may then send saved receipts to cloud wallet service 1002 through ISP/Gateway 1006 via wireless carrier 1013 where those receipts might be archived in cloud storage 1005 where they remain available for access.

In another aspect of the invention, after generating a QR code (1012) carrying receipt data as a result of a user transaction at the POS, POS 1007 may send the generated QR code 1012 directly to cloud wallet service 1002 via network access line 1014 and through ISP 1006 onto backbone 1001 and server 1004 aided by SW 1003. This aspect, the QR code is reconstructed into human readable form at server 1004 aided by SW 1003 and artificial intelligence (AI)-assisted receipt characterization processing may occur as may be made permissible by the user. Then the cloud wallet service 1002, more particularly server 1004, may push notification to the mobile phone 1008 of the user over backbone 101, through ISP/Gateway 1006 and onto wireless carrier 1006, the notification informing the user that one or more receipts are ready for task or modification by the user, the amendments made by the user and saved for archive by the service.

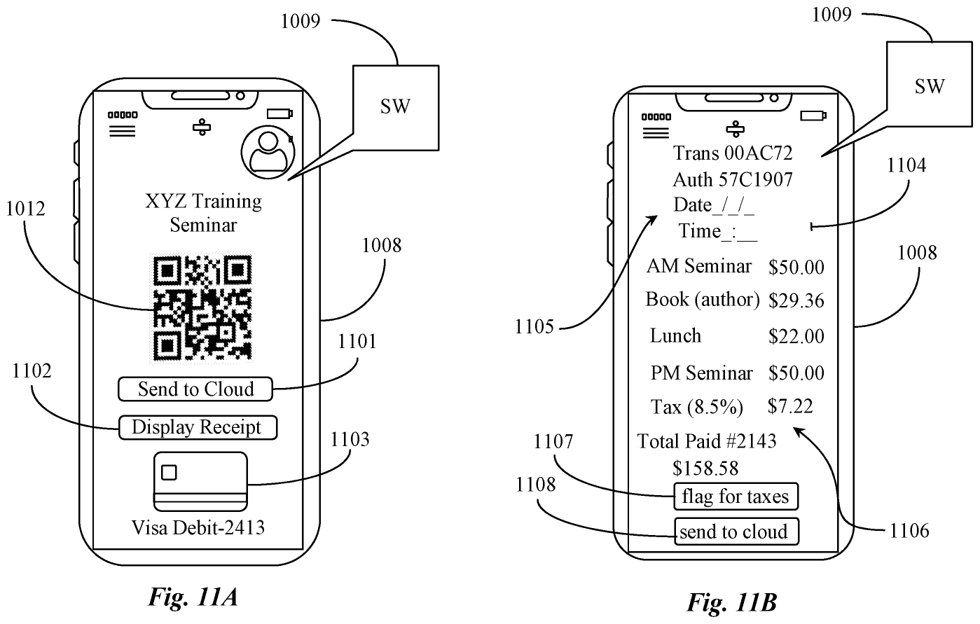

FIG. 11A is an elevation view of mobile phone 1008 displaying a receipt in the form of a scanned QR code. In this embodiment, the transaction has been conducted and the POS terminal has generated QR code 1012 and displayed it for capture, and Phone 1008 has captured same and is in the process of displaying same in application 1009. Application 1009 may be a thin client application downloaded from the user's cloud wallet service. The application screen may display the scanned in QR code 1012 along with at least a merchant logo for differentiating the code from another code.

Application 1009 may, in one embodiment, display the account iconic identification 1103 of the wallet account selected and used in the transaction that produced the QR code carrying the receipt data. These types of associations may be made by the system without requiring reconstructing the receipt data or other data included in the code. In one embodiment, a user may select send to cloud option 1101 to forward the captured and displayed code to the wallet service.

SW 1003 may use the meta data specifics about QR code 1012 to sort and basically to categorize the code for archival in cloud storage 1005 without needing to reconstruct the QR code for human legibility. In one embodiment all of the receipts are stored as QR codes if so generated. In such an embodiment, a user may be required to reconstruct the receipt from the QR code locally before viewing it in text.

In one embodiment, SW 1009 includes an option 1103 for reconstructing and displaying the data carried in the QR pattern for human reading and for audio synthesizing to electronic speech (if equipped) for playback. Selecting display receipt 1102 cause the QR application to reconstruct the QR data into form for display of at least a receipt listing all of the important data of the transaction covered.

FIG. 11B is an elevation view of mobile phone 1008 of 11A displaying a receipt containing data reconstructed from the QR code of 11A. In this view, a reconstructed receipt 1104 is displayed in the application screen as a result of the user interacting with the display receipt option 1102 of FIG. 11A. Receipt 1104 includes at least incident or event data 1105 like a transaction number, an authorization number, a data, and time of the transaction. A receipt content body 1106 may include the descriptive data and pricing paid or charges inferred. In this example, the user attended a training seminar, perhaps as part of a work or business function.

Receipt body 1106 breaks down what the user paid for over the entire seminar which is included in one transaction. The items listed in order include an AM seminar, a Book purchased during or after, followed by a lunch the user purchased, followed by a PM seminar, and accumulative tax for the book and lunch items. The receipt total is $158.58 taken from wallet account having the four last digits of the account number revealed as 2413. Additional data may be provided in the receipt data that is displayed for the user like merchant identification or come back advertising discounts.

In one embodiment the electronic receipt is one of multiple documents that the user has displayed for human reading. In this case the user may display the receipt and scroll to see other pages containing other data. SW 1009 may include a flagging option 1107 for the user to flag the receipt for tax deduction. Selecting this option may mark the receipt for tax flagging and open other options made available to ad meta data, add characterization, add text notes, add a hyperlink etc. The added data may be mapped to the receipt data and stored in human readable bur encrypted form.

In one embodiment, the wallet server aided by SW may generate a second QR code carrying the data of the first pattern and the new data added. In this form the new code may be stored in machine readable form and held in an encrypted state. In one embodiment, a send-to-cloud option 1108 is provided like option 1101 of FIG. 11A enabling the user to send the data to the cloud wallet service 1002 through the Internet connection and carrier network of the phone.

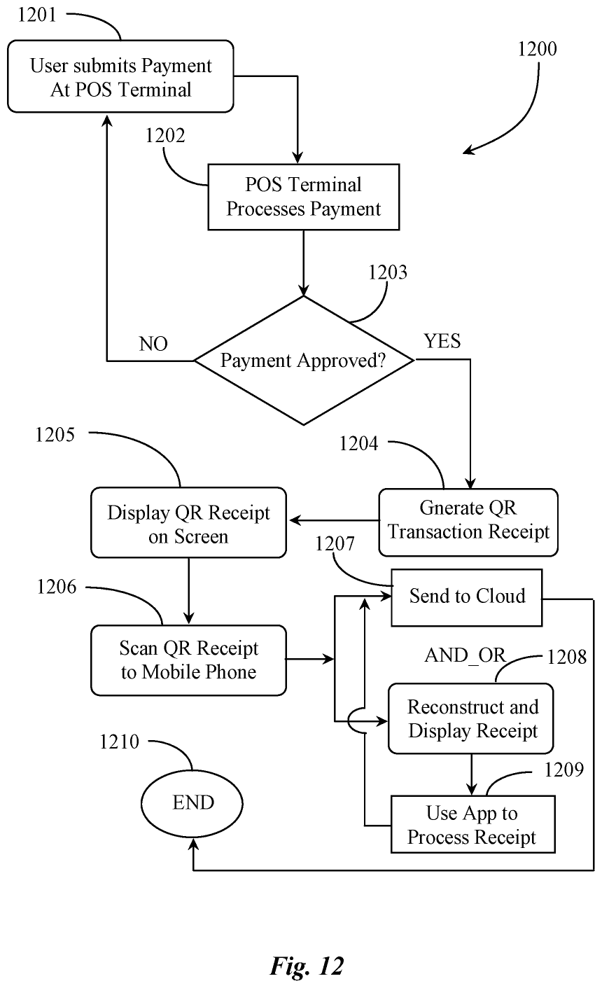

FIG. 12 is a process flow chart depicting steps 1200 for receipt capture and aggregation according to an embodiment of the present invention. At step 1201, a user submits payment to a POS terminal during a transaction. At step 1202, the POS terminal processes the payment submitted in step 1201. The user may pay with a card, a wearable transaction device like a watch, or with the mobile phone hosting the client application of the cloud wallet service or money pay application.

At step 1203, the POS terminal monitors to determine if the Payment made was approved for the transaction. If the payment was declined or otherwise not approved at step 1203, the process loops back to step 1201 where the user may try again with another payment account. If the payment is approved at step 1203, the POS terminal may generate a QR code representing at least the transaction receipt at step 1204. In this aspect, the POS terminal has a display screen that the user may see and interact with.

At step 1205, the POS terminal may display the generated QR code hosting the receipt data on the POS display screen. At step 1206, the user may scan the displayed QR code into the mobile phone through the client application leveraging a QR scanner/reader on the phone. In one embodiment, the user's card or wireless transaction device may send a wireless signal, notification, or command to the user's mobile phone when the transaction is being conducted wherein the signal notification or command results in execution of the client application if closed and execution of the QR scanning application used to scan the QR code in step 1206. However, it is not required to practice the present invention but is a convenience to the user.

The process branches where the user has two options onc3e the QR code is lifted from the POS terminal display. One option is sending the QR code to the cloud wallet service at step 1207 without reconstruction of the receipt locally. The other option is to reconstruct the receipt data for display on the user's mobile phone screen in the thin client application screen. In option 1207, the wallet service may receive the code from the user and process it according to the meta data already known about the transaction the merchant and the user's account used to pay for the transaction. After step 1207, the process may end for the user at step 1210. The cloud service may take care of the rest of the receipt processing and may send a push notification to the user after it is ready for access by the user.

If the user wishes, the QR code may be reconstructed relative to at least the receipt data and displayed on the user mobile phone in the client application as a human readable receipt in step 1208. At step 1209, the user may process the receipt for any allowed tasks such as tax flagging, merchant name redaction, categorization (business/account) send to third parties, add meta data, add to list, etc. in step 1209. The user may then send the process may loop back to 1207 where the receipt (in legible form) and any added meta data to the cloud wallet service for archiving on behalf of the subscribing user. The process may then end at step 1210 for the user. It is noted herein that receipt data accrued by a user operating a mobile phone with the thin client application may be provided in batches to the cloud wallet service whether in QR code form or in reconstructed receipt form.

In one aspect of the invention, the user may lift a generated QR code off of a paper medium printed at the POS terminal if there is no active display screen. In one aspect a transaction may be complicated like a loan document signing, a contract signing, a rental agreement, a blanket purchasing agreement, etc. These types of transactions may require more data to be loaded into the QR form than just the accounting or receipt data. The standard QR code form may hold several pages of text. There is a rectangular version of a QR code block that may hold more data and may be incorporated as well. In one aspect of complicated transaction, a merchant or service broker may generate more than one QR code as required for data rate wherein one QR code may hold receipt data and another QR code may hold associated contractual data. All of the QR data may be reconstructed locally or at the wallet service and may be rendered accessible for review edit, modification, and so on.

Receipt Capture Notification and Camera Activation from Remote Wallet or Money Pay Service

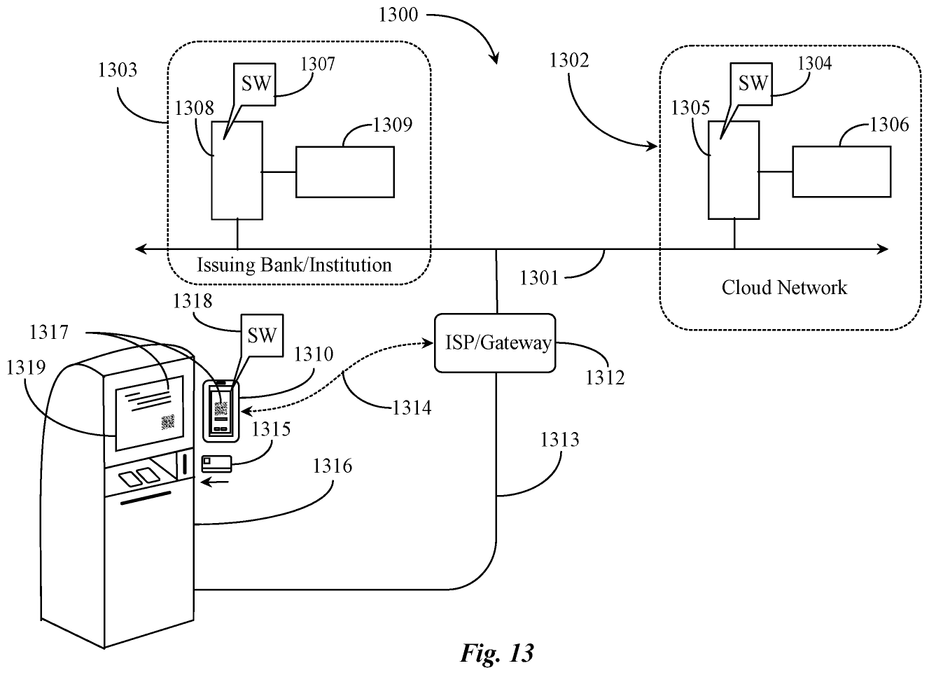

FIG. 13 is an architectural view of a communications network 1300 supporting automated receipt capture notification and activation via remote service. Communications network 1300 includes a network backbone 1301. Network backbone 1301 may represent all lines, equipment, access points, routers, and gateways that make up the network as a whole including connected sub networks. Communications network 1300 may be an Internet network or another wide-area-network (WAN) without departing from the spirit and scope of the present invention. There are no geographic limits to the practice of the invention.

Backbone 1301 supports a network cloud labeled cloud wallet service 1302. Cloud wallet service 1302 may be adapted by a financial mobile cloud wallet service company to store credit card data, debit card data, and other electronic card or account data, for a mobile user, represented herein as a user phone 1310 the user in possession of a dynamic transaction card 1315 that may be programed with a selected set of card transaction data, for example, to make a specific transaction. In a preferred embodiment, dynamic card 1315 may be loaded with card data from cloud wallet service 1302 through mobile phone 1310 to dynamic card 1315 using a wireless protocol, in this case Bluetooth™ light or BLE.

Cloud wallet service 1302 includes a server 1305 supported by back bone 1301 running a software (SW) application 1304 and coupled to a data repository 1306. SW 1304 may be a cloud wallet application or a money payment application for a dynamic transaction device like card 1310 or another type of device used to interact with a sales or banking terminal (electronic machine/network node) like a smart payment ring, payment watch of any other wearable capable of initiating a transaction at a POS etc . . . Data repository 1306 contains credentialed information of a user and may include user identification and profile data; user credit card and debit card accounts data, financial history data including transaction history, cloud wallet account data, and the like.

Access to communications network backbone 1301, which may represent the Internet in one embodiment, may be through an Internet service provider (ISP)/access Gateway 1312 supported by backbone 1301. A carrier network is depicted as a dotted line 1314 between ISP/Gateway 1312 that enables communications including wireless communications to be bridged onto communications network 1300 through ISP Gateway 1312 and mobile phone 1310 running a software application (SW) 1318.

Carrier network 1314 may be a wireless 5G network or similar mobile network that user-operated mobile phone 1310 may use to access the network and practice local and long-distance communications using the representative mobile telephone. Mobile telephone 1310 may be Bluetooth™ enabled. SW application 1318 may be adapted as a thin mobile SW client application including a network connection and browsing ability that may display information on a display device on mobile phone 1310.

The user operating mobile phone 1310 may be present at a business domain that may be a service site, restaurant, retail establishment, parks service, rental agency, lodging, or any venue that a user may patronize to buy a product or service. In this embodiment, a point of sale (POS) machine or terminal 1317 that takes, at least, credit and debit cards for satisfying financial transactions made by a user operating mobile phone 1310.

In this embodiment, a user operating mobile phone 1310 may have a dynamic transaction card 1310 (or other transaction device) that may be electronically associated to a funded account and may be accepted by terminal 1317 to pay for goods or services. In a preferred embodiment, user operating mobile phone 1310 may transmit account data to card 1315 from the mobile telephone while running SW 1318 and Bluetooth™ wherein the card 1310 is Bluetooth™ enabled to at least receive the account data (card number) wherein the account data represents an account that user operating mobile phone 1310 has subscribed to and is represented in cloud wallet service 1302.

It is noted herein that the components described above are the same or similar to counterparts described further above in FIG. 1 relative to architecture for receipt capture in general. A user operating mobile phone 1310 may have several different accounts represented in cloud network 1302 and dynamic transaction card 1315 may be loaded with any of the user's account data to use that account to pay for goods or services during a transaction. SW 1318 on mobile phone 1310 enables the user to interact with cloud network 1302 just before using card 1310 at POS terminal 1317 so that the user may determine which of several accounts might be imprinted or sent to card 1310 for use as a transaction device representing that account.

In a preferred embodiment, user accounts may be originally held at a financial institution that issues cards like credit and debit cards tied to those accounts. Network backbone 1301 supports an issuing bank or institution 1303 representing a bank or other institution that may serve customers in banking, loans, etc. Issuing bank 1303 includes a server 1308 hosting banking SW 1307 and a server-connected data repository 1309. SW 1307 running on server 1308 manages client accounts and activity and provides client access to general banking services including transferring funds between accounts, checking statements, and the like. Data repository 1309 represents banking data and client data including current account data and so on.

A user may load card 1315 with a card number, security code, and other pertinent data so the card may be used as a card of a selected account. Any new account data that the user loads onto card 1315 may overwrite any previous account data on the card memory. In a preferred embodiment, SW 1304 executing on server 1305 in cloud wallet service 1302 is adapted to at least receive and file electronic receipts on behalf of the active user operating mobile phone 1310 in near real time. Card 1315 may be used as the transaction device to pay for one or more transactions at POS terminal 1316. Card 1315 may be written to by mobile phone 1310 executing application 1318 in broad respect while card 1315, once written to, represents a particular account listed in cloud wallet service 1302.

In one embodiment, a user operating mobile phone 1310 aided by SW 1318 may select an account and have the account data written to card 115 over Bluetooth™ for use in a transaction at POS terminal 1316. In this embodiment, the POS 1316 reads the card and runs the data against data held at the issuing entity to verify the account and available funds to cover the transaction. In this embodiment, the POS terminal may generate a receipt upon transaction approval that may be displayed on POS screen 1319 in view of the user operating mobile phone 1315. SW 1304 running on cloud server 1305 may have access to a user's mobile phone camera capabilities through client application 1318.

The financial institution, in one embodiment sends a notification of successful card transaction to the client's wallet account, whereby the cloud service aided by SW 1304 running on server 1305 identifies the account and client and pushes a command from the cloud to the client's mobile phone 1315 to execute a receipt capture session through local client application 1318. In another embodiment, cloud wallet service 1302 may pull this information from the financial institution connected to the account selected for use by the user through an arrangement with permission granted by the shared user.

In both of the embodiments described above, the user's camera or scanner may be automatically readied to be used in a receipt capture mode or operation whereby the user operating mobile phone 1310, may capture a receipt 1317 from the POS screen 1319, and have it display in the client application on screen on the mobile phone. In one embodiment, the mobile phone is also the transaction device and near field communication (NFC) is used in transaction at the POS terminal. In one embodiment, a hard receipt is printed out by POS terminal on a connected printer for capture and retention by the user.

In one embodiment where the financial institution does not push a notification to the client's wallet service, the wallet service may access and monitor the account activity occurring at the financial institution in real time as the institution electronically handles the transaction verification and approval thereof. Through this wallet service monitoring the wallet service may then glean the transaction information and may send a push or other notification to mobile phone 1310 to initiate a receipt capture.

In one embodiment, the user operating the mobile phone may set a time window from the time interaction of selecting an account to use for the transaction to when the transaction is expected to occur. Therefore, after the user selects an account and writes the data to card, the cloud wallet service aided by SW 1304 may access the account with authentication provided by the user to monitor for the activity to the account expected to occur within the time window set. When the transaction is detected, the service 1302 may push the command to the user through the client application to execute the camera to capture the receipt into the client application 1318 where it may be displayed and other tasks may be performed before the receipt is synced or saved to the cloud service. Local application 1318 may be adapted to operate in background mode such that it uses less resource and is ready for task performance directly out of background mode. In the embodiment using active monitoring based on time window set by the client, the wallet service is not dependent upon receipt of a notification from the financial institution reporting the activity.

The window of time set by a user may be a small window such as minutes, hours, or longer periods such as half day, day, etc. Account monitoring may involve a proxy log-in to an account server handling the client account activity and may log out after detection of the transaction that occurred at the POS. The cloud service may update the user's account after receiving the receipt or after recording the debit or credit shift in the original account being monitored during the time window.

Monitoring may include a continuous listening for server activity involving the account in question, or a periodic check of the account status for the predicted activity. In an embodiment where the institution is willing to send detailed notification to the cloud wallet service, the service simply waits for notification but is dependent upon when the notification goes out. Ideally, the wallet service may execute the camera application through an extension in the client application on the mobile phone while the transaction is being validated.

In one embodiment, transaction card 1315 may be a dedicated card with a single data set tied to an account that is represented in the wallet service. Therefore, the method of notification and the path of notification does not depend upon having wireless communications capability between the mobile phone 1310 running the client application 1318 and the transaction device 1315.

The wallet service 1302 may be first alerted by the user selecting the dedicated transaction card (not dynamic) tied to the represented account through the thin client application. Though other ways and communications paths are available and feasible for transmitting a notification or command to start a capture session using the camera application on phone 1310, the method of the invention wherein the path is from the cloud service to the application running on the mobile phone may be practiced in real time as the transaction is being validated and requires less specificity of the capabilities of the POS terminal or the transaction devices making it more widely available.

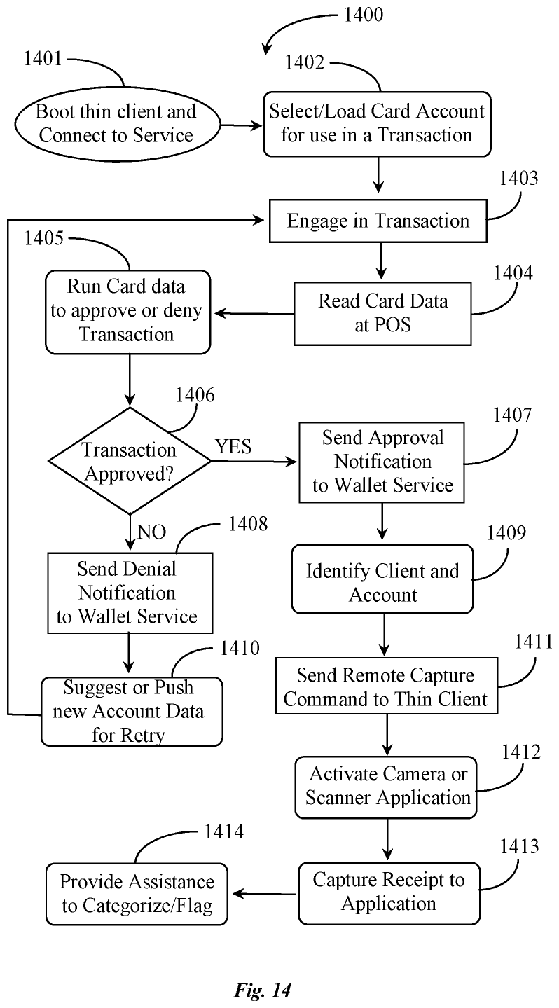

FIG. 14 is a process flow chart 1400 depicting steps for remote notification of receipt capture and camera activation according to one aspect. In this process flow at step 1401, a user operating a mobile phone with the wallet application client may boot the client application and connect via an ISP gateway wirelessly to the cloud wallet service through a wireless carrier network. The user may be preparing to engage in one or more transactions at a location having terminals to accept such transactions. At step 1402, the user may select a card account from a list of accounts available on the mobile phone in the thin client application for use in a pending transaction.

At step 1402, the account selected may cause account card set data to be transferred to a dynamic smart card to load the card with transacting data over a wireless connection like Bluetooth™. In another embodiment, the selected account is not loaded onto a dynamic card due to a fact that the user may be using a dedicated card having only one transacting data set in memory. In this case the account selection process is simply to alert the cloud wallet service of the intent to transact with a dedicated card tied to a cloud represented account. In one embodiment, the user may set a time window with which the selected account will be used to complete a transaction.

At step 1403, the user engages in a transaction at one of the POS terminals. The terminal may be adapted for one or more transaction device types and methods without departing from the spirit and scope of the present invention. In one embodiment, the phone may be the transaction device, a dedicated or a smart card may be the transaction device, a payment capable watch or payment capable ring, any payment capable wearable or other NFC capable device might also be used without affecting the basic method of the invention.

At step 1404, the POS terminal reads the transactional data set on the user's transaction device. At step 1405, the POS terminal runs the transactional data (card data) by contacting the issuing entity verifying the account the user and data and the availability of funds in the account to cover the transaction. At step 1406, the POS terminal gets an approval or a denial of the attempted transaction in the process of step 1405. At step 1406, if the transaction is approved, at step 1407, the account issuing entity like a bank for example, may send a notification of approval of the transaction to the cloud wallet service which may send a notification concerning capturing the receipt. At 1407 the cloud wallet service may also glean the transaction information from the card issuing bank or glean the information by observing the transaction in real time between POS and the card issuing bank and send receipt capture command to thin client.

At step 1408 if transaction is denied send notification to cloud wallet service of denial and suggestion to try again with new card.

At step 1409, the cloud wallet service having received approval notification identifies the client and account associated with the received notification. Ideally, the approval notification is received before the account activity occurs or the receipt for the approved transaction is generated at the POS terminal. In this line of process 1400, the cloud wallet service generates a command to access the user's camera features to the thin client application running on the user's mobile telephone, the camera feature or features executed automatically at step 1412 by the thin client application via an extension with permission of the client.

At step 1413, the user having the camera features activated, may then use the phone to capture the generated receipt from the POS terminal screen or from a printed hard copy. The capture event loads the receipt into the application for display and at step 1414, the application may provide tools to categorize, flag, mark, or amend the receipt before submitting the receipt through the application to the cloud service for storage in association with the account debited or credited, or otherwise modified by the transaction.

If the attempted transaction is denied or not approved in step 1406, then at step 1408, the issuing entity may send notification of denial to the cloud wallet service. It may be assumed that step 1409 may be repeated for a denial notification before step 1410. At step 1410, the cloud wallet service may push a different account data set that the service suggests should be used to be loaded on the transaction device for another transaction attempt, or at least make a suggestion to the user through the thin client to select a different account, which may then be loaded onto a dynamic card overwriting the previous card data. The process may then resolve back to step 1403 wherein the user may retry the transaction using the new data, the process looping accordingly until a receipt is captured and submitted for storage ending the process for that transaction.

In one embodiment, the process 1400 must be repeated from step 1402 for each transaction. In another embodiment, the user may when selecting an account to use for a first transaction, state a number of transactions that might occur within a time window using the same account transacting data set. In that case, the process 1400 (approval line of process) may be repeated from step 1404 for each transaction made.

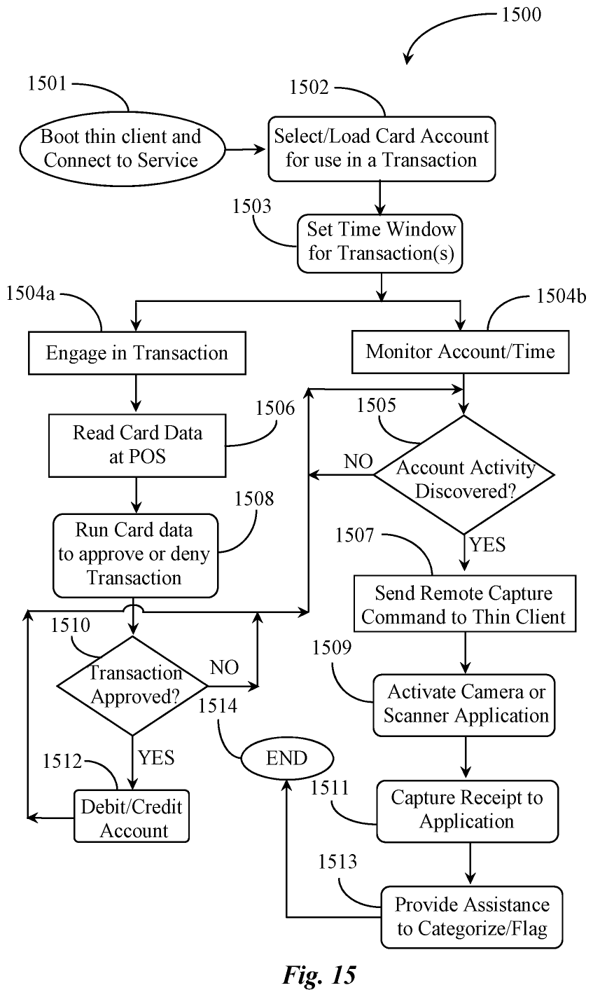

FIG. 15 is a process flow chart 1500 depicting steps for remote notification of receipt capture and camera activation according to another aspect. In this process, the first few steps 1501 and 1502 are analogous to steps 1401 and 1402. At step 1503 after selecting an account, the user may set a time window for an expected transaction to occur. The reason for setting a time window within which the expected transaction or transactions may be performed is for the purpose of enabling the wallet service to dedicate a resource such as connecting to a server, for example, at the issuing entity, and listening for activity. The activity may be a transaction approval or denial, or account access associated with the account selected in step 1502.

The cloud wallet service may connect to the issuing entity and may begin monitoring or listening for activity associated with the selected account during the time window set by the user at step 1504b. Concurrently, at least within the set time window, the user may engage in a first transaction at a POS terminal at step 1504a. While step 1504b is ongoing, the POS terminal may read the transaction card data at step 1506. The transaction data may be read in a number of ways or transmitted by wireless communication or data transfer (NFC) through an appropriate POS interface.

At step 1508, the POS runs the card data to verify the customer, account, and availability of funds therein to cover the transaction in process. At step 1510, the POS has discovered whether the transaction was approved or denied. If at step 1510, the transaction is not approved, then the process may resolve to step 1505. At step 1505, a determination is made by the cloud wallet service during the time window set by the user in step 1503, whether account activity has been discovered in association with the user's account. Account activity might be the issuing entity accessing the user account by monitored server(s) during the validation process to approve or deny the user's POS transaction.

If activity is still not detected at step 1505, then the process may loop back wherein listening continues for data evidence of account access and or debiting or crediting. Active or focused resource dedication by the cloud wallet service on behalf of the client or user may terminate if the activity was not detected within the time window set in step 1503. In one embodiment, the resource is a server connection that listens for activity associated with the selected account number.

This activity may include access to the account to determine funds available made by the bank server, for example. In that case, another process line described in FIG. 14 above with respect to step 1410. Even if the financial institution does not send an alert to the cloud wallet service if a card is denied, the cloud wallet service may infer that by discovery the account was accessed but no changes made to the account such as marking it for pending debit or credit.

If at step 1510, the transaction was approved, at step 1512, the issuing entity may mark or flag the account for debit or credit. The process may then resolve to step 1505 and continue through process steps 1507, 1509, 1511, and 1513, which are analogous to process steps 1411, 1412, 1413, and 1414 of FIG. 14, before ending for that transaction at step 1514.

In one embodiment, the thin client application may be executed and may assume a background role to other applications until the user taps to select an account where the application may assume a more dominant role in the foreground during interaction with the client after a receipt is captured. In one embodiment, execution of camera features to capture a receipt may occur with the application in background mode, wherein executing the camera features then causes the application to display on screen ready to receive the captured receipt. Once the receipt is worked and submitted to the cloud service over the network, the application may automatically drop back into the background mode of operation.

In one embodiment, the point of sale may be a Web-based terminal like a secure online sales checkout page where the transacting data sent to the user is immediately auto filled into the required card data fields on the order page and wherein the camera may be activated by the cloud service in the same manners described above to capture the receipt from display into the application where it may be processed by the user before submission to the service for archival. In this embodiment, a receipt may be printed from the mobile phone once the page is in display on the phone and the user may also take a hard picture of the receipt into the camera application.

It will be apparent with skill in the art that the method for capture of electronic receipts of the present invention may be provided using some or all the elements described herein. The arrangement of elements and functionality relative to the invention is described in different embodiments, each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A method for remotely activating a transaction receipt capture process on a mobile device through a client application from a network-connected cloud-based money payment or wallet service in light of an account issued to a user and incorporated into the service comprising:
(a) the user selecting an account listed in the service through the client application while connected to the service;
(b) the user receiving transactional data or otherwise confirmation of account selection at the mobile phone in the client application;
(c) the user submitting the transactional data to a point of sale (POS) terminal to complete the transaction;
(d) at the POS terminal, reading the submitted transactional data and approving or denying the transactional data for completing the transaction;
(e) at the service, receiving notification of or discovering account activity relative to the user account selected in (a); and
(f) at the service, sending a command to the mobile phone client application of the user to activate a camera or scanning application feature on the mobile phone through an extension in the client application.

2. The method of claim 1, wherein the network is the Internet network including any sub-networks connected thereto.

3. The method of claim 1, wherein in (c) the transaction device is a dynamic transaction card enabled for wireless communications with the mobile device acting as a host device.

4. The method of claim 1, wherein in (c) the transaction device is the mobile phone enabled with near field communication (NFC).

5. The method of claim 1, wherein in (c) the transaction device is a wearable device like a ring or watch enabled for wireless communications with the mobile phone acting as the host device.

6. The method of claim 1 further including a step in between step (b) and (c) for selecting or establishing a time window within which one or more transactions will be attempted using the selected account.

7. The method of claim 4, wherein in step (c) the transactional data is submitted to the POS terminal directly from the mobile phone operating as the transaction device.

8. The method of claim 3, wherein in step (c) the transactional data is submitted to the POS terminal through a dynamic transaction card.

9. The method of claim 5, wherein in step (c) the transactional data is submitted to the POS terminal through a wearable transaction device like a watch.

10. The method of claim 1, wherein in step (d) approving or denying the transactional data for completing the transaction is performed at the account issuing entity at request of the POS terminal.

11. The method of claim 1, wherein in step (e) the service receives notification of account activity from the issuing entity.

12. The method of claim 1, wherein in step (e) the service discovers the account activity through active monitoring of a server servicing the account or active monitoring of the electronic account.

13. The method of claim 11, wherein the notification includes approval or denial of the transactional data.

14. The method of claim 11, wherein the discovery includes flagging or marking the account for pending credit or debit based on the transactional nature.

15. The method of claim 1, wherein in step (f) the client application is operating in background mode and executes to foreground mode at the moment of execution of the received command to activate the camera or scanner application feature.

16. The method of claim 1, wherein in step (c) the transaction device is a dedicated card having a resident card number.
